(19) United States
(12) Patent Application Publication
(10) Pub. No.: US 2024/0197447 A1
(43) Pub. Date: Jun. 20, 2024

(54) INTRAORAL IMAGE PROCESSING APPARATUS AND INTRAORAL IMAGE PROCESSING METHOD

(71) Applicant: MEDIT CORP., Seoul (KR)

(72) Inventors: Sung Hoon Lee, Seoul (KR); Jin Young Kim, Seoul (KR)

(73) Assignee: MEDIT CORP., Seoul (KR)

(21) Appl. No.: 18/517,647

(22) Filed: Nov. 22, 2023

(30) Foreign Application Priority Data
Dec. 15, 2022 (KR) 10-2022-0176117
Jul. 3, 2023 (KR) 10-2023-0085980

(51) Int. Cl. A61C 9/00; G06T 5/70; G06T 19/20

(52) U.S. Cl. CPC A61C 9/0053; G06T 5/70; G06T 19/20; G06T 2210/44; G06T 2219/2021

(57) ABSTRACT

Provided are an intraoral image processing apparatus and an intraoral image processing method. The intraoral image processing method includes obtaining an original model and a resultant model for an object, modifying, based on a user input, a shape of one of the original model and the resultant model, and modifying, based on the modified shape, a shape of the other one of the original model and the resultant model.

### CROSS-REFERENCE TO RELATED APPLICATION

This application is based on and claims priority under 35 U.S.C. § 119 to Korean Patent Application Nos. 10-2022-0176117, filed on Dec. 15, 2022, and 10-2023-0085980, filed on Jul. 3, 2023, in the Korean Intellectual Property Office, the disclosures of which are incorporated by reference herein in their entireties.

### BACKGROUND

### 1. Field

The disclosure relates to an intraoral image processing apparatus and an intraoral image processing method. More particularly, the disclosure relates to an intraoral image processing apparatus capable of modifying a shape of an intraoral image and an intraoral image processing method.

### 2. Description of the Related Art

Recently, a method of obtaining intraoral images of a patient using a 3D scanner has been used as an intraoral information acquisition method. The 3D scan data of objects, such as the teeth, gums, and jawbone of the patient may be obtained by scanning the oral cavity of the patient using a 3D scanner, and the obtained 3D scan data is used for dental treatment, orthodontic treatment, prosthetic treatment, etc.

The obtained 3D scan data is also used for orthodontic simulation to show patients the progress of orthodontic treatment or intraoral images before the orthodontic treatment and predicted intraoral images after the orthodontic treatment. During an actual orthodontic treatment, at least one tooth is moved to a desired position, and the shape of the gingiva is naturally changed as the tooth moves. Like real orthodontic treatment, the orthodontic simulation may move the teeth of an original model, which is an intraoral image before the orthodontic treatment, to the desired position, and may show a resultant model of predicted results after the orthodontic treatment by modifying the shape of the gingiva as the teeth move. In this case, the original model and the resultant model may have a certain relationship with each other. For example, the teeth of the original model and the teeth of the resultant model may have different positions, but the same shape. Also, for example, the gingiva of the original model and the gingiva of the resultant model may have a transformed relationship depending on certain factors.

Also, if the original model or resultant model created through the orthodontic simulation incorrectly reflects the intraoral information of the patient, or if an effective consultation with the patient is required, there is a need to modify the shape of the original model or the resultant model. Since the original model and the resultant model have images before and after orthodontic correction for the same patient, if the shape of either the original model or the resultant model is modified, there is a need to reflect this modified shape in the other model.

In addition, since the original model and the resultant model have images before and after orthodontic correction for the same patient, even if the shape of either the original model or the resultant model is modified, there is a need to maintain the original relationship between the original model and the resultant model.

### SUMMARY

Provided are an intraoral image processing apparatus and an intraoral image processing method, which may provide an original model before orthodontic treatment and a resultant model after the orthodontic treatment through orthodontic simulation.

Provided are an intraoral image processing apparatus and an intraoral image processing method, whereby, if a shape of either an original model or a resultant model is modified, the modified shape may be reflected in the other model.

Provided are an intraoral image processing apparatus and an intraoral image processing method, whereby, even if a shape of either an original model or a resultant model is modified, a relationship between the original model and the resultant model remains the same.

Additional aspects will be set forth in part in the description which follows and, in part, will be apparent from the description, or may be learned by practice of the presented embodiments of the disclosure.

According to an aspect of the disclosure, an intraoral image processing method includes obtaining an original model and a resultant model for an object, modifying, based on a user input, a shape of one of the original model and the resultant model, and modifying, based on the modified shape, a shape of the other one of the original model and the resultant model.

The intraoral image processing method according to an embodiment may further include modifying the other one of the original model and the resultant model while one of the original model and the resultant model is being modified.

The modifying of the shape of the other one of the original model and the resultant model may include modifying the original model or the resultant model in which there has been no user input.

The modifying of the shape of the one of the original model and the resultant model may include at least one of convexly sculpting the shape of the object, concavely sculpting the shape of the object, smoothing the shape of the object, and morphing the shape of the object.

The intraoral image processing method according to an embodiment may include modifying, based on the user input based on the user input, a shape of a tooth in one of the original model and the resultant model, and modifying, based on the modified shape of the tooth, a shape of a tooth in the other one of the original model and the resultant model, wherein the shape of the original tooth in the original model is same as the shape of the resultant tooth in the resultant model.

The intraoral image processing method according to an embodiment may further include obtaining a resultant tooth of the resultant model that is moved according to a linear transformation applied to an original tooth of the original model, modifying a shape of the original tooth based on the user input, and obtaining a modified resultant tooth by moving the modified original tooth according to the linear transformation.

The intraoral image processing method according to an embodiment may further include obtaining the resultant model having a resultant tooth that is moved according to a linear transformation applied to an original tooth of the original model, modifying a shape of the resultant tooth based on the user input, and obtaining a modified original tooth by moving the modified resultant tooth according to an inverse-linear transformation.

The intraoral image processing method according to an embodiment may further include modifying, based on the user input, a shape of a gingiva in one of the original model and the resultant model and modifying, based on the modified shape of the gingiva, a shape of a gingiva in the other one of the original model and the resultant model, wherein the shape of the resultant gingiva of the resultant model is modified by reflecting a movement of a tooth in the shape of the original gingiva of the original model.

The intraoral image processing method according to an embodiment may include obtaining the resultant model having a resultant gingiva modified by reflecting an amount of a tooth movement in an original gingiva of the original model, modifying a shape of the original gingiva based on the user input, and modifying a shape of the resultant gingiva by reflecting the amount of the tooth movement in the modified original gingiva.

The intraoral image processing method according to an embodiment may further include obtaining the resultant model having a resultant gingiva modified by reflecting the amount of the tooth movement in an original gingiva of the original model, primarily modifying a shape of the resultant gingiva based on the user input, modifying the shape of the original gingiva based on the primarily modified resultant gingiva, and secondarily modifying the shape of the resultant gingiva by reflecting the amount of tooth movement in the modified original gingiva.

The modifying of the shape of the original gingiva based on the primarily modified resultant gingiva may include obtaining a target point of the original gingiva in response to a user input point of the primarily modified resultant gingiva and modifying the original gingiva based on a direction of a normal vector for a target point of the original gingiva.

The modifying of the shape of the resultant gingiva or the secondarily modifying of the shape of the resultant gingiva may include modifying or secondarily modifying the shape of the resultant gingiva, based on release of the user input.

The intraoral image processing method according to an embodiment may further include obtaining a plurality of resultant models for the object, modifying, based on a user input, a shape of one among the original model and the plurality of resultant models, and modifying, based on the modified shape, shapes of the other models among the original model and the plurality of resultant models.

According to another aspect of the disclosure, an intraoral image processing apparatus includes a display, memory storing one or more instructions, and at least one processor, wherein the at least one processor is configured to execute the one or more instructions to obtain an original model and a resultant model for an object, modify, based on a user input, a shape of one of the original model and the resultant model, and modify, based on the modified shape, a shape of the other one of the original model and the resultant model.

According to another aspect of the disclosure, a computer-readable recording medium records a program for performing one of the methods described above and below.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view for explaining an intraoral image processing system according to an embodiment;

FIG. 2 is a view for explaining an orthodontic simulation performed by using an intraoral image processing apparatus according to an embodiment;

FIG. 3 is a flowchart showing an intraoral image processing method according to an embodiment;

FIG. 4 is a view illustrating a method of sculpting an intraoral model using an intraoral image processing apparatus according to an embodiment;

FIG. 5 is a view illustrating an operation of obtaining teeth of a resultant model that are modified as teeth of an original model are modified by the intraoral image processing apparatus according to an embodiment;

FIG. 6A is a view for explaining a relationship between the teeth of the original model and the teeth of the resultant model, according to an embodiment;

FIG. 6B is a view for explaining a relationship between the teeth of the original model and the teeth of the resultant model, according to an embodiment;

FIG. 7 is a view illustrating an operation of obtaining teeth of an original model that are modified as teeth of a resultant model are modified, according to an embodiment;

FIG. 8A is a view for explaining a relationship between the teeth of the original model and the teeth of the resultant model, according to an embodiment;

FIG. 8B is a view for explaining a relationship between the teeth of the original model and the teeth of the resultant model, according to an embodiment;

FIG. 9 is a view for explaining a relationship between the gingiva of the original model and the gingiva of the resultant model, according to an embodiment;

FIGS. 10 and 11 are views illustrating an operation of obtaining the gingivae of the resultant model that are modified as the gingivae of the original model are modified by the intraoral image processing apparatus according to an embodiment;

FIG. 12 is a view for explaining a relationship between the gingiva of the original model and the gingiva of the resultant model, according to an embodiment;

FIGS. 13 and 14 are views illustrating an operation of obtaining the gingivae of the original model that are modified as the gingivae of the resultant model are modified by the intraoral image processing apparatus according to an embodiment;

FIG. 15 is a view showing orthodontic simulations depending on a plurality of scenarios according to an embodiment;

FIG. 16 is a view showing an original model and a resultant model in an intraoral image processing apparatus according to an embodiment; and

FIG. 17 is a block diagram of an intraoral image processing apparatus according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

This specification describes principles of the disclosure and sets forth embodiments thereof to clarify the scope of rights of the disclosure and to allow those skilled in the art to practice the embodiments of the disclosure. The embodiments disclosed herein may have different forms.

Like reference numerals refer to like elements throughout. This specification does not describe all elements of embodiments, and general information in the technical field to which the disclosure belongs or a repeated description between embodiments is omitted. The term ‘part or portion’ used herein may be provided as software or hardware, and a plurality of ‘portions’ may be provided as a single unit or element depending on embodiments. Also, a single ‘part or portion’ may include a plurality of elements. Hereinafter, operation principles and embodiments of the disclosure are described with reference to the accompanying drawings.

An image used herein may include an image that shows at least one teeth or an oral cavity including at least one teeth (hereinafter, referred to as an ‘intraoral image’).

Also, the image used herein may include a two-dimensional image of an object, or a three-dimensional model or a three-dimensional image that shows the object in three dimensions. In addition, the image used herein may refer to data required to represent an object in two or three dimensions, for example, raw data obtained from at least one image sensor. Specifically, the raw data may refer to data acquired to create an image and may include data (e.g., 2-dimensional (2D) data) obtained from at least one image sensor included in a 3D scanner when scanning an object using a 3-dimensional (3D) scanner.

An ‘object’ used herein may include the teeth, the gingiva, at least a portion of the oral cavity, a tooth model, and/or an artificial structure that may be inserted into the oral cavity (e.g., an orthodontic device, an implant, an artificial tooth, an orthodontic aid inserted into the oral cavity, etc.). The orthodontic device may include at least one of a bracket, an attachment, an orthodontic screw, a lingual orthodontic device, and a removable orthodontic retainer.

A ‘3D intraoral image’ as used herein may include various polygonal meshes. For example, when two-dimensional data is obtained using a 3D scanner, the intraoral image processing apparatus may calculate the coordinates of a plurality of illuminated surface points using a triangulation method. The 3D scanner used herein scans the surface of an object while moving along the surface thereof. Accordingly, the amount of scan data increases, and the coordinates of surface points may be accumulated. As a result of the image acquisition, a point cloud of vertices may be identified to represent the range of the surface. Points within the point cloud may represent actual measured points on the 3-dimensional surface of the object. The surface structure may be approximated by forming a polygonal mesh in which adjacent vertices of the point cloud are connected to each other by line segments. The polygonal mesh may be defined in various forms, such as a triangular, quadrangular, or pentagonal mesh. The relationships between polygons of the mesh model and neighboring polygons may be used to extract characteristics of teeth boundaries, such as curvature, minimum curvature, edges, and spatial relationships.

As used herein, ‘morphing’ may refer to an operation that deforms (or changes or modifies) the shape of an object. For example, the ‘morphing’ may refer to changing the positions or normal directions of polygonal meshes while maintaining the number of polygonal meshes constituting the object and the connection relationship between vertices. As used herein, ‘gingival morphing’ may refer to an operation of modifying the shape of the gingiva such that the shape of the gingiva is naturally modified when the teeth are moved by the orthodontic correction. Also, for example, a ‘morphing function’ among ‘sculpting functions’ may refer to an operation of modifying the shape of an object according to an input of a user.

Hereinafter, embodiments are described in detail with reference to the drawings.

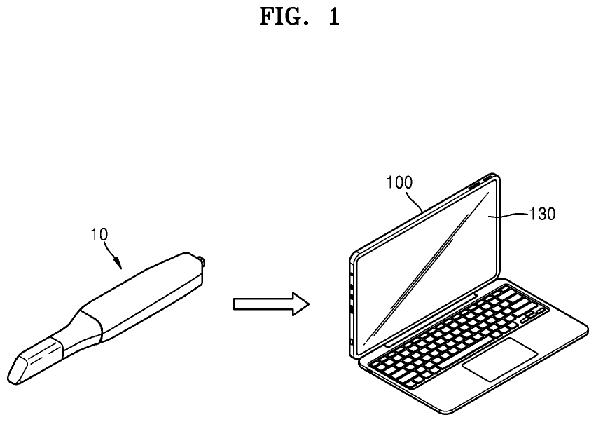

FIG. 1 is a view for explaining an intraoral image processing system according to an embodiment.

Referring to FIG. 1, the intraoral image processing system includes a 3D scanner 10 and an intraoral image processing apparatus 100.

The 3D scanner 10 according to an embodiment may include a medical device that obtains an image of an object by scanning the object. The 3D scanner 10 may obtain an image of at least one of an oral cavity, an artificial structure, and a plaster model of the oral cavity or artificial structure.

FIG. 1 illustrates the 3D scanner 10 as a handheld scanner that a user holds in the hand to scan an object, but the embodiment is not limited thereto. For example, the 3D scanner 10 may include a model scanner in which a tooth model is installed and the installed tooth model is scanned while moving.

For example, the 3D scanner 10 may include a device that is inserted into the oral cavity and scan the teeth in a non-contact manner so as to obtain an image of the oral cavity including at least one tooth. Also, the 3D scanner 10 may have a form that is inserted into and withdrawn from the oral cavity of a patient and scan the inside of the oral cavity using at least one image sensor (e.g., an optical camera, etc.).

The 3D scanner 10 may obtain surface information about an object as raw data in order to image the surface of the object. Here, the object may include at least one of the teeth, the gingiva, teeth models in the oral cavity and artificial structures that are inserted into the oral cavity (e.g., orthodontic devices including brackets and wires, implants, artificial teeth, orthodontic aids inserted into the oral cavity, etc.).

The 3D scanner 10 may transmit the obtained raw data to the intraoral image processing apparatus 100 via a wired or wireless communication network. The image data obtained by the 3D scanner 10 may be transmitted to the intraoral image processing apparatus 100 connected via the wired or wireless communication network.

The intraoral image processing apparatus 100 may include all electronic devices which may be connected to the 3D scanner 10 via a wired or wireless communication network, receive a 2D image obtained by the 3D scanner 10 scanning the object, and generate and process an image based on the received 2D image, and display and/or transmit the image.

The intraoral image processing apparatus 100 may include computing devices, such as a smart phone, a laptop computer, a desktop computer, a personal digital assistant (PDA), or a tablet personal computer (PC), but the embodiment is not limited thereto. In addition, the intraoral image processing apparatus 100 may be provided in the form of a server (or a server device) for processing intraoral images.

The intraoral image processing apparatus 100 may process 2D image data received from the 3D scanner 10 to generate information or may process 2D image data to generate an image. Also, the intraoral image processing apparatus 100 may display the generated information and images via a display 130.

For example, the 3D scanner 10 may directly transmit the raw data obtained through scanning to the intraoral image processing apparatus 100. In the intraoral image processing apparatus 100 according to an embodiment, when the raw data obtained by scanning the object is received from the 3D scanner 10, a 3D intraoral image representing the oral cavity in three dimensions may be generated based on the received raw data. Based on the received raw data, the intraoral image processing apparatus 100 according to an embodiment may generate 3D data (e.g., surface data, mesh data, etc.) that three-dimensionally represents the shape of the surface of the object.

Also, a ‘3D intraoral image’ may be generated by three-dimensionally modeling an object on the basis of the received raw data and thus may be referred to as a ‘3D intraoral model.’ Hereinafter, a model or image representing an object in two or three dimensions is collectively referred to as an ‘intraoral model’ or ‘intraoral image.’

The intraoral image processing apparatus 100 may analyze, process, display, and/or transmit the generated intraoral image.

Also, for example, the 3D scanner 10 may obtain raw data by scanning an object, process the obtained raw data to generate an image corresponding to the object, and transmit the image to the intraoral image processing apparatus 100. In this case, the intraoral image processing apparatus 100 may analyze, process, display, and/or transmit the received image.

In the embodiment disclosed herein, the intraoral image processing apparatus 100 includes an electronic device capable of generating and displaying an intraoral image that three-dimensionally represents the oral cavity including one or more teeth. The intraoral image processing apparatus 100 according to an embodiment may use the generated intraoral image to perform orthodontic simulation. The intraoral image processing apparatus 100 according to an embodiment may show a patient a progress of orthodontic treatment by executing orthodontic simulation, or may show an intraoral image after the orthodontic treatment, which is predicted from the intraoral image of the patient before the orthodontic treatment. As described above, the intraoral image processing apparatus 100 shows patients the state of the teeth before orthodontic correction and the state of teeth predicted after the orthodontic correction, and thus, the patients may predict how much their dental conditions are changed due to the orthodontic treatment.

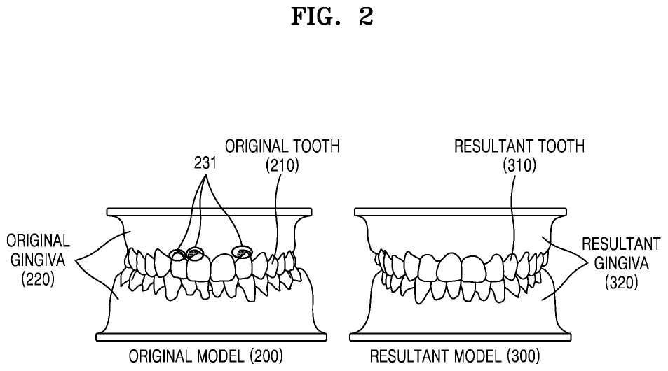

Hereinafter, the intraoral image processing apparatus 100 and the orthodontic simulation are described in more detail with reference to FIG. 2 together with FIG. 1.

FIG. 2 is a view for explaining the orthodontic simulation of the intraoral image processing apparatus 100 according to an embodiment.

Referring to FIGS. 1 and 2, when the intraoral image processing apparatus 100 according to an embodiment receives raw data obtained by the 3D scanner 10 that scans the oral cavity, the received raw data may be processed to create a 3D intraoral model. The raw data received from the 3D scanner 10 may include raw data representing the teeth and raw data representing the gingiva. Accordingly, the 3D intraoral model generated by the intraoral image processing apparatus 100 may include a tooth region representing the teeth and a gingival region representing the gingiva. In the intraoral image processing apparatus 100 according to an embodiment, the tooth region and the gingival region may be separated from each other. Also, the intraoral image processing apparatus 100 according to an embodiment may individualize the teeth in the tooth region. The teeth in the tooth region are separated from each other, and the intraoral image processing apparatus 100 may include shape information, position information, and the like for each of the teeth.

According to an embodiment, the intraoral image processing apparatus 100 may generate an original model 200 on the basis of the tooth region and gingival region which are included in the 3D intraoral model. For example, the original model 200 may correspond to the states of the teeth and gingiva of a patient before the orthodontic correction. In an embodiment, the original model 200 may include an original tooth 210 corresponding to the state of the patient's tooth before the orthodontic correction and an original gingiva 220 corresponding to the state of patient's gingival before the orthodontic correction. For example, the original tooth 210 and the original gingiva 220 may be separated from each other.

According to an embodiment, the intraoral image processing apparatus 100 may execute the orthodontic simulation and generate a resultant model 300 after the orthodontic treatment, which is predicted from the original model 200. For example, the resultant model 300 may include a resultant tooth 310 obtained by predicting the state of the patient's tooth after the orthodontic correction and a resultant gingiva 320 obtained by predicting the state of the patient's gingiva after the orthodontic correction. For example, the resultant tooth 310 and the resultant gingiva 320 may be separated from each other.

During actual orthodontic treatment, at least one tooth is moved to a desired position, and the shape of the gingiva is naturally changed as the tooth moves. The intraoral image processing apparatus 100 according to an embodiment may move the teeth to desired positions through the orthodontic simulation and modify the shape of the gingiva on the basis of the movement of the teeth. For example, the intraoral image processing apparatus 100 may generate the resultant tooth 310 located at the desired position by moving the original tooth 210 and may generate the resultant gingiva 320 by reflecting the movement of the original tooth 210 in the original gingiva 220. For example, the resultant gingiva 320 may have a shape modified by reflecting the amount of tooth movement in the original gingiva 220. For example, the amount of tooth movement may be based on displacement indicating the movement of the tooth, but the embodiment is not limited thereto.

For example, the intraoral image processing apparatus 100 may modify the shape of the gingiva on the basis of the movement of teeth, and this operation disclosed herein may be referred to as ‘gingival morphing.’ For example, the intraoral image processing apparatus 100 may perform the gingival morphing. Accordingly, the positions or normal directions of polygonal meshes may be modified based on the movement of the teeth while the number of polygonal meshes included in the gingival mesh data remains the same. For example, the number of the polygonal meshes included in the gingival mesh data before the orthodontic correction is same as the number of the polygonal meshes included in the gingival mesh data after the orthodontic correction. For example, a mesh deformation technique may be used to modify the gingiva.

For example, the resultant gingiva 320 may have a shape modified by reflecting the movement of the teeth in the original gingiva 220. Therefore, it can be said that the resultant gingiva 320 has a shape in which the original gingiva 220 is morphed. For example, the original gingiva 220 and the resultant gingiva 320 may maintain a morphing relationship, which is a modification relationship based on the movement of teeth.

Also, the intraoral image processing apparatus 100 according to an embodiment may morph the gingiva, considering various control factors in addition to the amount of tooth movement in order to provide a patient with a more natural image of the teeth and gingiva after the orthodontic correction, but a description thereof is omitted herein.

The original model 200 or resultant model 300 generated in the intraoral image processing apparatus 100 according to an embodiment may incorrectly reflect the intraoral information of a patient or may be inappropriate for consulting with the patient. In this case, the original model 200 or resultant model 300 needs to be modified to correctly reflect the intraoral information of the patient and to provide appropriate consultation with the patient. Also, in the intraoral image processing apparatus 100 according to an embodiment, the original model 200 or resultant model 300 may need to be modified for effective consultation with the patient.

For example, the original model 200 of FIG. 2 may incorrectly reflect the oral information of a patient because the original tooth 210 is created in a shape 231 that protrudes through the original gingiva 220. In this case, the original model 200 needs to be modified to correctly reflect the patient's oral information. Also, for example, when some of the patient's teeth are extracted, the gingival region adjacent to the extracted teeth may be created in an unorganized form in the original model 200 and the resultant model 300. Also, for example, if some of the patient's teeth are broken, the original model 200 and the resultant model 300 may reflect the broken teeth, which may not be aesthetically pleasing. In this case, the original model 200 and the resultant model 300 need to be modified for effective consultation with the patient.

In the intraoral image processing apparatus 100 according to an embodiment, when the shape of any one of the original model 200 and the resultant model 300 is modified, the modified shape may be reflected in the shape of the other one of the original model 200 and the resultant model 300.

That is, the original model 200 and the resultant model 300 include images before and after the orthodontic correction for the same patient. Therefore, regardless of the orthodontic treatment, the relationship between the original model 200 and the resultant model 300 needs to be maintained even after the shape of either the original model 200 or the resultant model 300 is modified. For example, regarding the teeth, the shape of the teeth before the orthodontic correction and the shape of the teeth after the orthodontic correction for the same patient have to remain the same. Also, regarding the gingiva, the gingiva before the orthodontic correction and the gingiva after the orthodontic correction for the same patient have to maintain a relationship (a morphing relationship) modified on the basis of the movement of teeth.

For example, when the shape of the tooth in one of the original model 200 and the resultant model 300 is modified, the intraoral image processing apparatus 100 may reflect the modified shape in the shape of the tooth in the other one. For example, when the shape of the gingiva in one of the original model 200 and the resultant model 300 is modified, the intraoral image processing apparatus 100 may reflect the modified shape in the shape of the gingiva in the other one.

The intraoral image processing apparatus 100 according to an embodiment may synchronize the shape deformation of the original model 200 and the shape deformation of the resultant model 300. When the shape of any one of the original model 200 and the resultant model 300 is modified, the intraoral image processing apparatus 100 according to an embodiment may automatically reflect the modified shape in the other one. The intraoral image processing apparatus 100 according to an embodiment may maintain the relationship between the original model 200 and the resultant model 300 even if the shape of either the original model 200 or the resultant model 300 is modified.

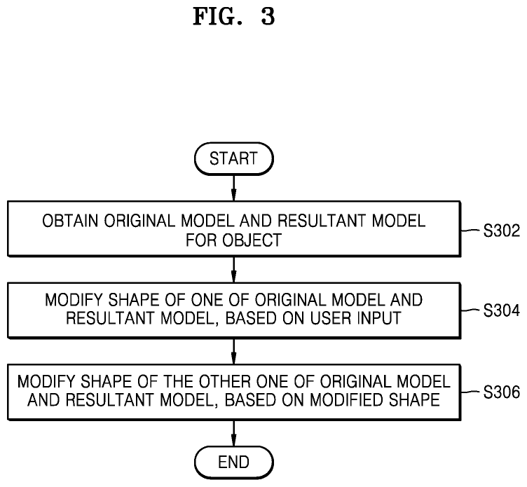

FIG. 3 is a flowchart showing an intraoral image processing method according to an embodiment.

Referring to FIG. 3, in operation S302, the intraoral image processing apparatus 100 according to an embodiment may obtain the original model 200 and the resultant model 300 for an object.

For example, the intraoral image processing apparatus 100 may use the 3D scanner 10 to obtain 3D scan data for the object, such as the teeth or gingiva of a patient. For example, scan data may be expressed as mesh data that includes a plurality of polygonal meshes. For example, the intraoral image processing apparatus 100 may obtain an intraoral image corresponding to the object. For example, the intraoral image processing apparatus 100 may use the intraoral image to perform the orthodontic simulation. For example, the intraoral image processing apparatus 100 may execute the orthodontic simulation to generate the intraoral image after the orthodontic treatment, which is predicted from the patient's intraoral image before the orthodontic treatment.

For example, the intraoral image processing apparatus 100 may obtain a 3D intraoral model corresponding to the patient's intraoral image before the orthodontic treatment. For example, the intraoral image processing apparatus 100 may obtain the original model 200 and may acquire the original tooth 210 and the original gingiva 220 on the basis of the tooth region and the gingival region included in the 3D intraoral model. For example, the original tooth 210 and the original gingiva 220 may be separated from each other. For example, the teeth included in the original tooth 210 may be individualized. For example, the intraoral image processing apparatus 100 may include shape information, position information, and the like for each of the teeth.

For example, the intraoral image processing apparatus 100 may predict an intraoral image after the orthodontic treatment, which is predicted from the original model 200. For example, the intraoral image processing apparatus 100 may obtain the resultant model 300. For example, the intraoral image processing apparatus 100 may obtain the resultant tooth 310 obtained by predicting the state of the patient's tooth after the orthodontic correction and the resultant gingiva 320 obtained by predicting the state of the patient's gingiva after the orthodontic correction. For example, the resultant tooth 310 and the resultant gingiva 320 may be separated from each other.

For example, as in an actual orthodontic treatment, the intraoral image processing apparatus 100 may create the resultant tooth 310 by moving the original tooth 210 to a desired position and may create the resultant gingiva 320 by modifying the shape of the original gingiva 220 on the basis of the movement of tooth. For example, in the intraoral image processing apparatus 100, the original tooth 210 of the original model 200 and the resultant tooth 310 of the resultant model 300 may have different positions but the same shape. For example, in the intraoral image processing apparatus 100, the original gingiva 220 of the original model 200 and the resultant gingiva 320 of the resultant model 300 have different shapes. However, the relationship therebetween that is modified based on the movement of the teeth may remain the same. For example, the resultant gingiva 320 may have a shape modified by reflecting the amount of movement of a tooth in the original gingiva 220. For example, the amount of movement of a tooth may be based on displacement indicating the movement of the tooth, but the embodiment is not limited thereto. For example, the resultant gingiva 320 may have a shape modified by reflecting, in the original gingiva 220, the amount of movement of the tooth and one or more control factors.

For example, the intraoral image processing apparatus 100 may simultaneously display the original model 200 having images of teeth before the orthodontic treatment and the resultant model 300 having images of teeth after the orthodontic treatment. For example, in the intraoral image processing apparatus 100, the original model 200 and the resultant model 300 may be displayed together on the display 130.

In operation S304, the intraoral image processing apparatus 100 according to an embodiment may modify the shape of one of the original model 200 and the resultant model 300 on the basis of a user input.

For example, the intraoral image processing apparatus 100 may receive the user input that modifies the shape of either the original model 200 or the resultant model 300. For example, the intraoral image processing apparatus 100 may provide a sculpting function, and a user may modify the shape of the original model 200 or the resultant model 300 using the sculpting function. For example, the intraoral image processing apparatus 100 may modify mesh data for intraoral images using sculpting functions. For example, the sculpting functions may include at least one of a shape adding function, a shape removing function, a shape smoothing function, and a shape morphing function. However, the embodiment is not limited thereto.

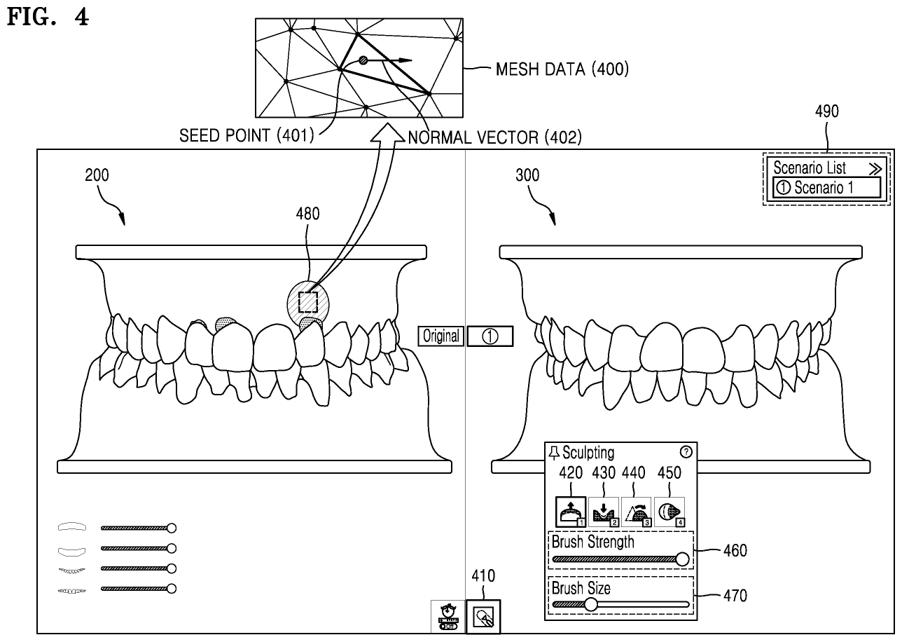

For example, the intraoral image processing apparatus 100 displays a menu corresponding to the sculpting function. When the displayed menu is selected by the user input, the mesh data may be modified using a function corresponding to the selected menu. This is described in detail with reference to FIG. 4.

For example, the intraoral image processing apparatus 100 may modify the shape of the original model 200 on the basis of the user input. For example, the intraoral image processing apparatus 100 may modify the shape of the original tooth 210 or original gingiva 220 on the basis of the user input.

For example, the intraoral image processing apparatus 100 may modify the shape of the resultant model 300 on the basis of the user input. For example, the intraoral image processing apparatus 100 may modify the shape of the resultant tooth 310 or resultant gingiva 320 on the basis of the user input.

For example, if a tooth is broken in the original model 200 of a patient, the user may add tooth mesh data to the broken part using the shape adding function. For example, if the original tooth 210 protrudes through the original gingiva 220 in the original model 200 of a patient, the user may add gingival mesh data to a region, through which the tooth protrudes, using the shape adding function.

In operation S306, the intraoral image processing apparatus 100 according to an embodiment may modify the shape of the other one of the original model 200 and the resultant model 300 on the basis of the modified shape. The intraoral image processing apparatus 100 according to an embodiment may modify the original model 200 or the resultant model 300 in which there has been no user input. The intraoral image processing apparatus 100 according to an embodiment may modify the other one of the original model 200 and the resultant model 300 while one of the original model 200 and the resultant model 300 is being modified.

In the intraoral image processing apparatus 100 according to an embodiment, when the shape of any one of the original model 200 and the resultant model 300 is modified, the modified shape may be reflected in the shape of the other one of the original model 200 and the resultant model 300.

The intraoral image processing apparatus 100 according to an embodiment may modify the shape of the tooth of one of the original model 200 and the resultant model 300 on the basis of the user input. The intraoral image processing apparatus 100 according to an embodiment may modify the shape of the tooth of the other one of the original model 200 and the resultant model 300 on the basis of the modified shape of tooth. For example, in the intraoral image processing apparatus 100, the resultant tooth 310 or the original tooth 210, in which there has been no user input, may be modified due to the modification of the original tooth 210 or the resultant tooth 310, in which there has been a user input, so that the original tooth 210 and the resultant tooth 310 may have the same shape.

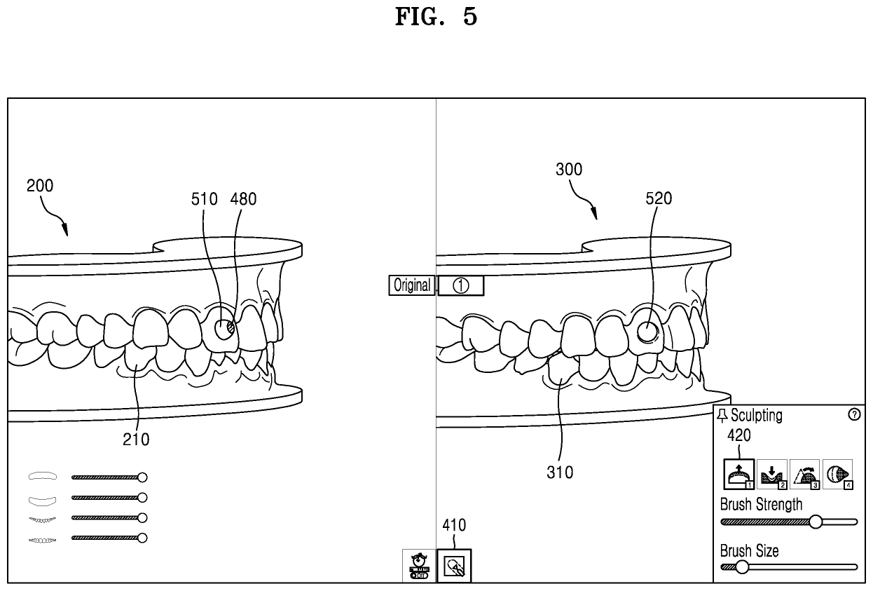

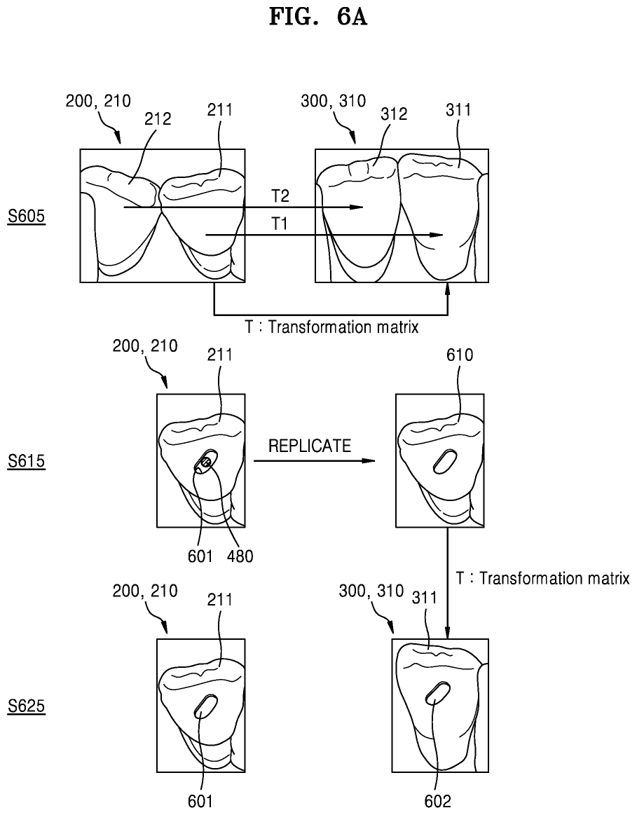

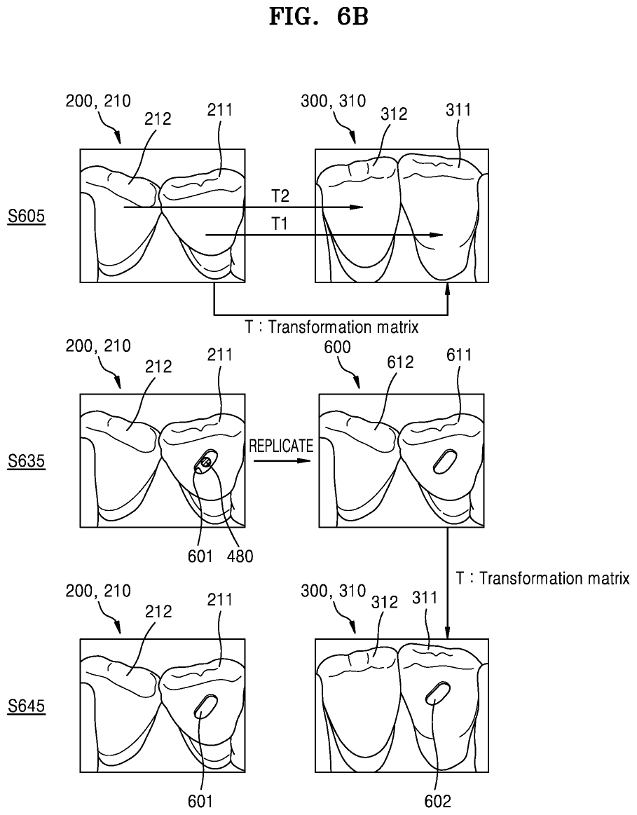

For example, the intraoral image processing apparatus 100 may modify the shape of the resultant tooth 310 on the basis of the shape of the original tooth 210 being modified by the user input. For example, the intraoral image processing apparatus 100 may reflect the modified shape of the original tooth 210 in the resultant tooth 310. This is described in detail in FIGS. 5 and 6.

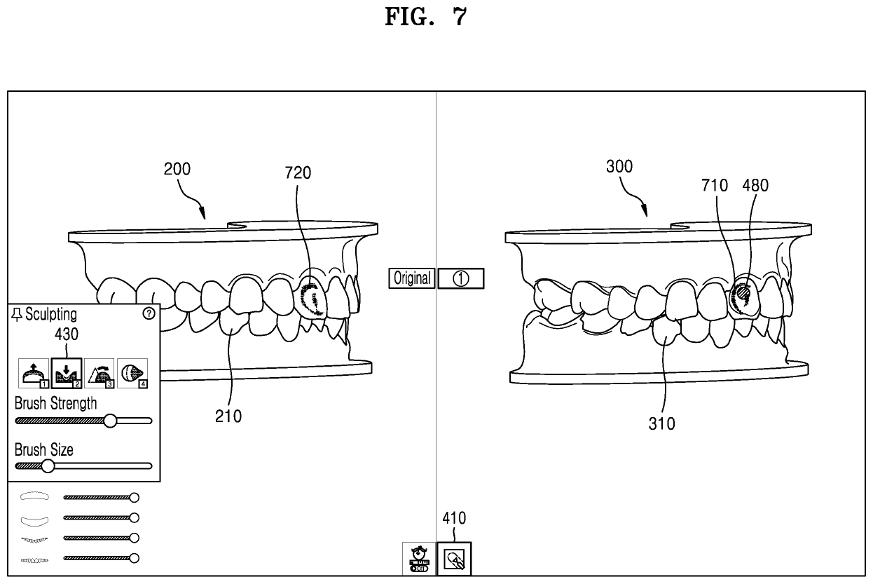

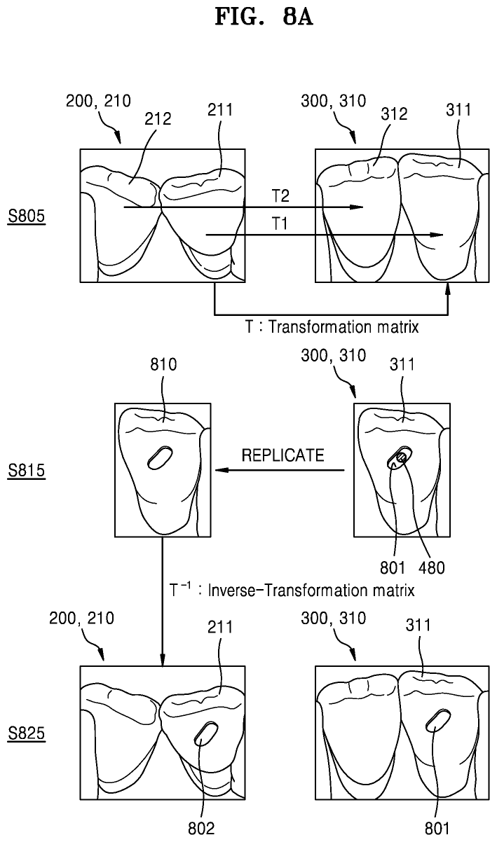

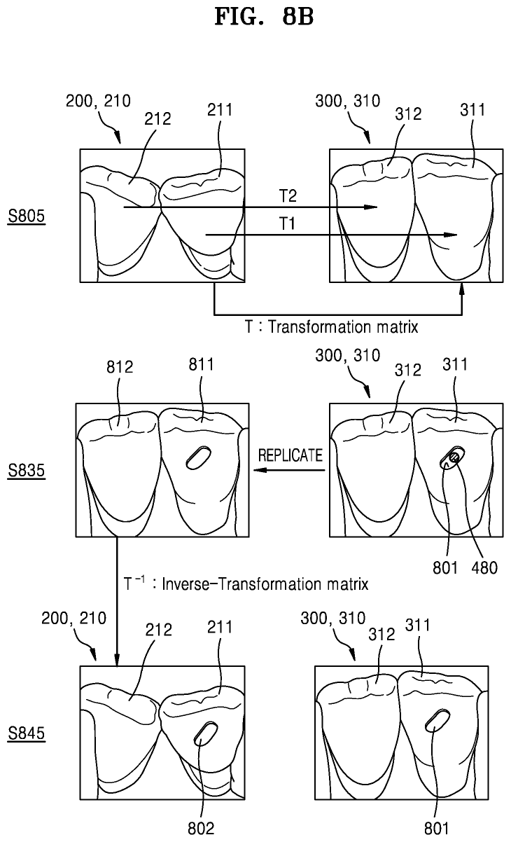

For example, the intraoral image processing apparatus 100 may modify the shape of the original tooth 210 on the basis of the shape of the resultant tooth 310 being modified by the user input. For example, the intraoral image processing apparatus 100 may reflect the modified shape of the resultant tooth 310 in the original tooth 210. This is described in more detail in FIGS. 7 and 8.

The intraoral image processing apparatus 100 according to an embodiment may modify the shape of the gingiva of one of the original model 200 and the resultant model 300 on the basis of the user input. The intraoral image processing apparatus 100 according to an embodiment may modify the shape of the gingiva of the other one of the original model 200 and the resultant model 300 on the basis of the modified shape of gingiva. For example, in the intraoral image processing apparatus 100, the resultant gingiva 320 or the original gingiva 220, in which there has been no user input, may be modified due to the modification of the original gingiva 220 or the resultant gingiva 320, in which there has been a user input, so that the original gingiva 220 and the resultant gingiva 320 maintain a modification relationship based on the movement of tooth.

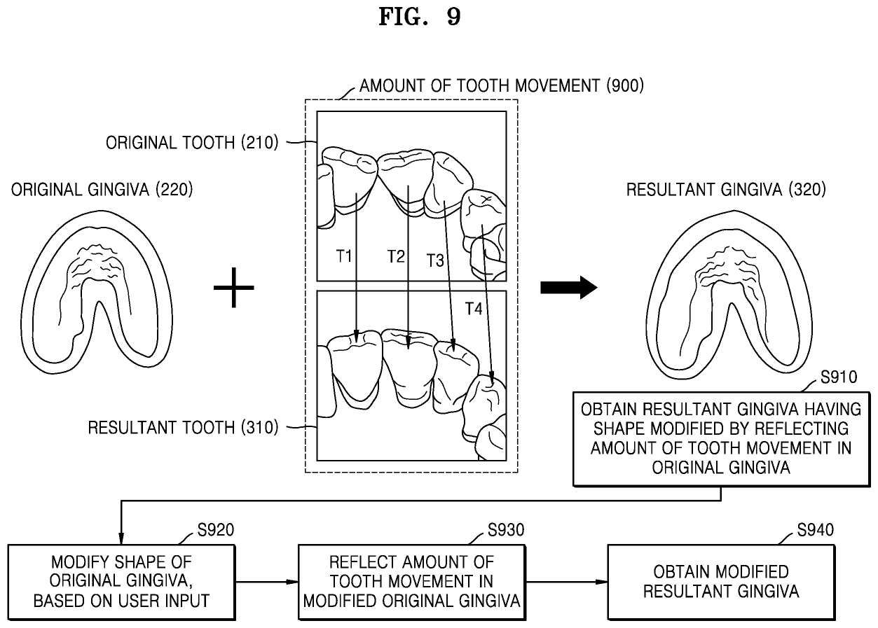

For example, the intraoral image processing apparatus 100 may modify the shape of the resultant gingiva 320 on the basis of the shape of the original gingiva 220 being modified by the user input. For example, the intraoral image processing apparatus 100 may generate the resultant gingiva 320 having a modification relationship with the modified original gingiva 220 on the basis of the movement of tooth. This is described in more detail in FIGS. 9 to 11.

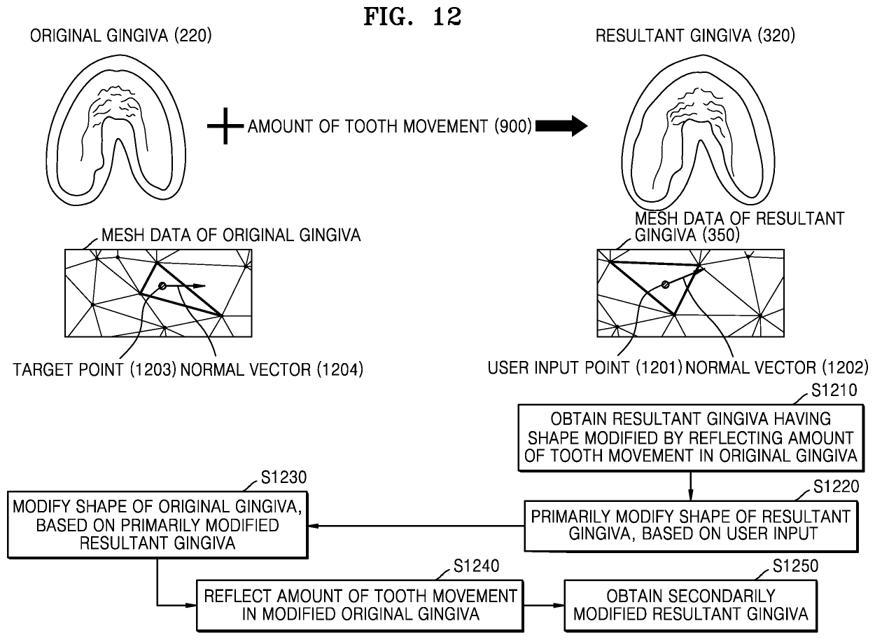

For example, the intraoral image processing apparatus 100 may modify the shape of the original gingiva 220 on the basis of the shape of the resultant gingiva 320 being modified by the user input. For example, the intraoral image processing apparatus 100 may generate the original gingiva 220 having a modification relationship with the modified resultant gingiva 320 on the basis of the movement of tooth. This is described in more detail in FIGS. 12 to 14.

The intraoral image processing apparatus 100 according to an embodiment may synchronize the shape deformation of the original model 200 and the shape deformation of the resultant model 300. When the shape of any one of the original model 200 and the resultant model 300 is modified, the intraoral image processing apparatus 100 according to an embodiment may automatically reflect the modified shape in the other one. The intraoral image processing apparatus 100 according to an embodiment may maintain the relationship between the original model 200 and the resultant model 300 even if the shape of either the original model 200 or the resultant model 300 is modified.

FIG. 4 is a view illustrating a method of sculpting an intraoral model using the intraoral image processing apparatus 100 according to an embodiment.

Referring to FIG. 4, the intraoral image processing apparatus 100 according to an embodiment may provide a sculpting function. For example, the intraoral image processing apparatus 100 may modify the shape of an object using sculpting functions. For example, the intraoral image processing apparatus 100 may modify the mesh data of the object.

The intraoral image processing apparatus 100 may display, on a screen, a sculpting menu 410 corresponding to the sculpting function. The sculpting menu 410 may include a first menu item 420 corresponding to a function of adding a shape, a second menu item 430 corresponding to a function of removing a shape, a third menu item 440 corresponding to a function of smoothing a shape, and a fourth menu item 450 corresponding to a function of morphing a shape.

The shape adding function may sculpt a shape such that the shape protrudes convexly, by increasing the sizes of meshes included in the mesh data or by increasing the number of meshes. For example, the shape adding function may include a function of adding the number of meshes when the size of the mesh increases and becomes greater than or equal to a certain size, but the embodiment is not limited thereto.

The shape removing function may sculpt a shape such that the shape is recessed concavely, by reducing the sizes of meshes included in the mesh data or by reducing the number of meshes. For example, the shape removing function may include a function of removing the number of meshes when the size of the mesh decreases and becomes less than or equal to a certain size, but the embodiment is not limited thereto.

The shape smoothing function may smoothly sculpt a shape so that the shape has smooth curved surfaces, by moving the points of meshes or adding or removing meshes. For example, the shape smoothing function may smooth the shape by adding meshes if the points of meshes are widely distributed. For example, the shape smoothing function may smooth the shape by removing meshes if the points of meshes are densely packed.

The shape morphing function may refer to changing the positions or normal directions of polygonal meshes while maintaining the number of polygonal meshes included in the mesh data and the connection relationship between vertices.

For example, the intraoral image processing apparatus 100 may perform any one of adding a shape, removing a shape, smoothing a shape, and morphing a shape. For example, the intraoral image processing apparatus 100 may sculpt a shape so that the shape protrudes convexly through the shape adding operation. For example, the intraoral image processing apparatus 100 may sculpt a shape so that the shape is recessed convexly through the shape removing operation. For example, the intraoral image processing apparatus 100 may add a shape to or remove a shape from the original model 200 and/or the resultant model 300 or may smooth or morph a shape of the original model 200 and/or the resultant model 300.

Also, the sculpting menu 410 may include an item 460 of adjusting brush strength and an item 470 of adjusting a brush size. However, the embodiment is not limited thereto.

Based on the set brush strength and brush size, the intraoral image processing apparatus 100 may determine the amount by which the size of the mesh increases or decreases, the amount by which the number of meshes is added or removed, the rate at which the size of the mesh increases or decreases, or the rate at which the number of meshes is added or removed.

When receiving a user input by which one of the first to fourth menu items 420, 430, 440, and 450 is selected, the intraoral image processing apparatus 100 may display a brush icon 480 on the screen. For example, based on a user input for selecting the first menu item 420, the intraoral image processing apparatus 100 may display the brush icon 480.

When the brush icon 480 is displayed, the user may move the displayed brush icon 480 on the screen. The intraoral image processing apparatus 100 may add a shape to or remove a shape from a region in which the brush icon 480 passes or may smooth or morph a shape of the region in which the brush icon 480 passes.

In order to perform the shape adding function or the shape removing function, the intraoral image processing apparatus 100 according to an embodiment may determine the direction, in which a shape is added or removed, and increase or decrease the size of the mesh in the determined direction. For example, the intraoral image processing apparatus 100 may identify a screen point, which is a point input on the display 130 by a user. The intraoral image processing apparatus 100 may obtain a straight line in a screen normal direction, which is a direction going into the plane of the display 130 at the screen point. The intraoral image processing apparatus 100 may convert the screen point into a seed point 401 on a mesh and convert the screen normal into a normal vector 402 on the mesh. For example, the intraoral image processing apparatus 100 may obtain the seed point 401, which is a point at which a straight line in the screen normal direction meets a specific mesh of a mesh data 400. For example, the seed point 401 may include an arbitrary point on a specific mesh of an object. The intraoral image processing apparatus 100 may calculate the coordinates of the seed point 401. For example, the intraoral image processing apparatus 100 may use the barycentric coordinate system so as to calculate the coordinates of the seed point 401. For example, the intraoral image processing apparatus 100 may use an area ratio of three triangles formed by connecting the seed point 401 and the three vertices of a triangular mesh including the seed point 401 to each other, thereby calculating the coordinates of the seed point 401. The intraoral image processing apparatus 100 may calculate the normal vector 402 for the seed point 401 on the basis of the calculated coordinates of the seed point 401. The intraoral image processing apparatus 100 may determine a direction to increase or decrease the size of the mesh on the basis of the normal vector 402. The intraoral image processing apparatus 100 may move the vertices of the mesh in the direction of the normal vector 402.

The intraoral image processing apparatus 100 according to an embodiment may move the vertices of each of meshes included in a brush region through which the brush icon 480 passes, on the basis of the seed point 401. Accordingly, the size of the meshes may be increased or decreased. For example, the amount by which the vertices of the meshes move may be determined by the distance from the seed point as a variable. When the size of the meshes becomes greater than or equal to a certain size, the intraoral image processing apparatus 100 may add the number of meshes instead of adjusting the size of the meshes. Also, when the size of the meshes becomes less than or equal to a certain size, the intraoral image processing apparatus 100 may remove the number of meshes instead of adjusting the size of the meshes. Additionally, if the brush region is smaller than the density of any one mesh, the intraoral image processing apparatus 100 may divide the meshes to increase the number of meshes, thereby performing a function of adding or removing a shape.

In the disclosure, the seed point 401 may be referred to as a ‘user input point’ for an object.

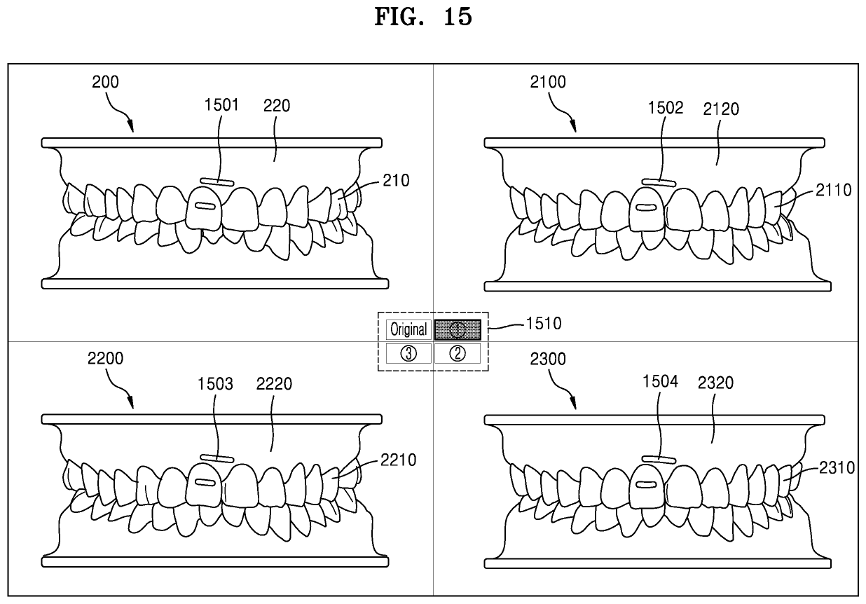

Also, the intraoral image processing apparatus 100 according to an embodiment may provide an orthodontic simulation according to a first scenario and may display, on a screen, a scenario menu 490 indicating that the resultant model 300 displayed on the screen is a 3D intraoral model according to the first scenario. Also, the intraoral image processing apparatus 100 may provide orthodontic simulations according to a plurality of scenarios, which is described in detail in FIG. 15.

Hereinafter, a process, in which the intraoral image processing apparatus 100 according to an embodiment modifies the resultant tooth 310 on the basis of the modification of the original tooth 210, is described with reference to FIGS. 5, 6A, and 6B.

FIG. 5 is a view illustrating an operation of obtaining teeth of the resultant model 300 that are modified as teeth of the original model 200 are modified by the intraoral image processing apparatus according to an embodiment.

Referring to FIG. 5, the intraoral image processing apparatus 100 according to an embodiment may obtain a user input that modifies the shape of the original tooth 210 of the original model 200. The intraoral image processing apparatus 100 may modify the shape of the original tooth 210 on the basis of the user input. The intraoral image processing apparatus 100 may obtain the resultant tooth 310 that is modified based on the modified original tooth 210.

For example, the intraoral image processing apparatus 100 may obtain a user input for moving the brush icon 480 in a state in which the first menu item 420 is selected. For example, the intraoral image processing apparatus 100 may add a shape to a region through which the brush icon 480 passes. For example, the intraoral image processing apparatus 100 may increase the size of the mesh of or add the number of meshes to the outer surface of the original tooth 210 corresponding to a region 510, through which the brush icon 480 has passed, and may thus sculpt the shape of the original tooth 210 to protrude outward.

For example, the intraoral image processing apparatus 100 may add a shape to the outer surface of the resultant tooth 310 having the same information as the original tooth 210 corresponding to the region 510 through which the brush icon 480 has passed. For example, the intraoral image processing apparatus 100 may increase the size of the mesh of or add the number of meshes to a region 520 of the resultant tooth 310 having the same shape information and the same position information as the modified original tooth 210. In this case, there may be no individual user input to the resultant tooth 310.

For example, the intraoral image processing apparatus 100 may obtain the resultant tooth 310 having the same shape as the original tooth 210 that has been modified on the basis of the user input.

For example, the intraoral image processing apparatus 100 may control the display 130 to display the modified original model 200 and the modified resultant model 300 together. For example, the intraoral image processing apparatus 100 may modify the resultant model 300 in real time while the original model 200 is being modified. For example, the intraoral image processing apparatus 100 may synchronize the original model 200 and the resultant model 300. Also, for example, the intraoral image processing apparatus 100 may modify the resultant model 300 on the basis of release of the user input that modifies the original model 200.

In the embodiment disclosed herein, release of user input can indicate a state in which user input has been removed or dropped.

FIG. 6A is a view for explaining a relationship between the teeth of the original model 200 and the teeth of the resultant model 300, according to an embodiment.

Referring to FIG. 6A, in the intraoral image processing apparatus 100 according to an embodiment, the original tooth 210 of the original model 200 and the resultant tooth 310 of the resultant model 300 may have different positions but the same shape. When the shape of one of the original tooth 210 and the resultant tooth 310 is modified, the intraoral image processing apparatus 100 according to an embodiment may modify the shape of the other one to the same shape.

In operation S605, the intraoral image processing apparatus 100 according to an embodiment may obtain the resultant tooth 310 of the resultant model 300 that is moved according to a linear transformation applied to the original tooth 210 included in the original model 200. For example, the original tooth 210 and the resultant tooth 310 may have a linear transformation relationship.

For example, the intraoral image processing apparatus 100 may obtain the coordinates of the resultant tooth 310 by applying a transformation matrix T to the coordinates of the original tooth 210. For example, the transformation matrix T may include a displacement transformation component or a rotation transformation component. For example, the intraoral image processing apparatus 100 may obtain the coordinates of the resultant tooth 310, which are moved by the displacement transformation component from the coordinates of the original tooth 210, by using the transformation matrix T having the displacement transformation component. For example, the intraoral image processing apparatus 100 may obtain the coordinates of the resultant tooth 310, which are rotated by the rotation transformation component from the coordinates of the original tooth 210, by using the transformation matrix T having the rotation transformation component.

For example, the displacement transformation component or rotation transformation component included in the transformation matrix T may determine the amount of tooth movement from the original tooth 210 to the resultant tooth 310. For example, the amount of tooth movement may be determined according to a transformation matrix T that moves individual teeth included in the original tooth 210.

For example, each of the individual teeth 211 and 212 (or referred to as a first original tooth 211 and a second original tooth 212) included in the original tooth 210 may be moved to desired positions on the basis of transformation matrices T1 and T2 (or referred to as a first transformation matrix T1 and a second transformation matrix T2) having different transformation components. For example, the first original tooth 211 may be transformed into a first resultant tooth 311 on the basis of the first transformation matrix T1. For example, the second original tooth 212 may be transformed into a second resultant tooth 312 on the basis of the second transformation matrix T2. The first transformation matrix T1 and the second transformation matrix T2 may have different transformation components. Accordingly, the amounts of movements of individual teeth may be different from each other.

In an embodiment, the transformation matrix T may include a 4×4 transformation matrix. For example, the intraoral image processing apparatus 100 may transform 3-dimensional coordinates (x, y, z) into 4-dimensional coordinates (x, y, z, a) using a homogeneous coordinate system. For example, the intraoral image processing apparatus 100 may acquire coordinates that are moved or rotated by multiplying the transformed 4-dimensional coordinates by the transformation matrix T. Here, the homogeneous coordinate system may be used to express the movement or rotation of 3-dimensional coordinates as the product of transformation matrix T. However, the embodiment is not limited thereto, and the transformation matrix T may include a 2×2 transformation matrix or a 3×3 transformation matrix.

In operation S615, the intraoral image processing apparatus 100 according to an embodiment may modify the shape of the original tooth 210 on the basis of a user input. The intraoral image processing apparatus 100 according to an embodiment may generate a replicated tooth 610 by replicating the modified original tooth 210.

For example, the intraoral image processing apparatus 100 may reduce the size of the mesh of or remove the number of meshes from a region 601, through which the brush icon 480 has passed, in a state in which a shape removing function is selected. For example, the intraoral image processing apparatus 100 may obtain the first original tooth 211 in which a shape has been removed from the region 601.

For example, the intraoral image processing apparatus 100 may generate the replicated tooth 610 having the same shape as the first original tooth 211 in which the shape has been removed from the region 601. For example, the intraoral image processing apparatus 100 may replicate only a specific tooth of which the shape has been modified. For example, the intraoral image processing apparatus 100 may replicate the first original tooth 211 and may not replicate the second original tooth 212 of which the shape has not been modified. Also, the replicated tooth 610 may not be displayed on the intraoral image processing apparatus 100, but the embodiment is not limited thereto.

In operation S625, the intraoral image processing apparatus 100 according to an embodiment may obtain the modified resultant tooth 310 by moving the modified original tooth 210 according to the linear transformation. For example, the intraoral image processing apparatus 100 may apply the transformation matrix T to the replicated tooth 610 so as to obtain the resultant tooth 310 of which the coordinates have been moved. For example, the intraoral image processing apparatus 100 may apply the transformation matrix T to the replicated tooth 610, which has been formed by replicating the modified first original tooth 211, and thus obtain the first resultant tooth 311.

In an embodiment, the intraoral image processing apparatus 100 may obtain the first resultant tooth 311 of which a region 602 corresponding to the region 601 of the first original tooth 211 is modified. For example, the intraoral image processing apparatus 100 may obtain the first resultant tooth 311 in which a shape has been removed from the region 602. For example, the intraoral image processing apparatus 100 may obtain the first resultant tooth 311 having the shape synchronized with that of the first original tooth 211.

FIG. 6B is a view for explaining a relationship between the teeth of the original model 200 and the teeth of the resultant model 300, according to an embodiment.

Referring to FIG. 6B, when replicating the original tooth 210, the intraoral image processing apparatus 100 according to an embodiment replicates not only the first original tooth 211 of which the shape has been modified, but also the remaining teeth (e.g., the second original tooth 212) of which the shape has not been modified. For this reason, the embodiment of FIG. 6B is different from the embodiment of FIG. 6A. For example, the intraoral image processing apparatus 100 may generate a replicated model 600 and replicated teeth 611 and 612 that have the same shape as the original tooth 210. Hereinafter, a description focuses on differences from FIG. 6A.

In operation S635, the intraoral image processing apparatus 100 according to an embodiment may generate the replicated model 600, which is formed by replicating the original tooth 210, on the basis of the original tooth 210 of which the shape has been modified. For example, the replicated model 600 may include the teeth 611 and 612 respectively formed by replicating the first original tooth 211 and the second original tooth 212.

In operation S645, the intraoral image processing apparatus 100 according to an embodiment may apply the transformation matrix T to the replicated model 600 so as to obtain the resultant tooth 310 of which the coordinates have been moved. For example, the intraoral image processing apparatus 100 may obtain the first resultant tooth 311 and the second resultant tooth 312.

Hereinafter, a process, in which the intraoral image processing apparatus 100 according to an embodiment modifies the original tooth 210 on the basis of the modification of the resultant tooth 310, is described with reference to FIGS. 7, 8A, and 8B.

FIG. 7 is a view illustrating an operation of obtaining teeth of the original model 200 that are modified as teeth of the resultant model 300 are modified, according to an embodiment.

Referring to FIG. 7, the intraoral image processing apparatus 100 according to an embodiment may obtain a user input that modifies the shape of the resultant tooth 310 of the resultant model 300. The intraoral image processing apparatus 100 may modify the shape of the resultant tooth 310 on the basis of the user input. The intraoral image processing apparatus 100 may obtain the original tooth 210 that is modified based on the modified resultant tooth 310.

For example, the intraoral image processing apparatus 100 may obtain a user input for moving the brush icon 480 in a state in which the second menu item 430 is selected. For example, the intraoral image processing apparatus 100 may remove a shape from a region through which the brush icon 480 passes. For example, the intraoral image processing apparatus 100 may reduce the size of the mesh of or remove the number of meshes from the outer surface of the resultant tooth 310 corresponding to a region 710, through which the brush icon 480 has passed.

For example, the intraoral image processing apparatus 100 may remove a shape of the original tooth 210 having the same information as the resultant tooth 310 corresponding to the region 710 through which the brush icon 480 has passed. For example, the intraoral image processing apparatus 100 may remove a shape from a region 720 of the original tooth 210 having the same shape information and the same position information as the modified resultant tooth 310. In this case, there may be no separate user input on the original tooth 210.

For example, the intraoral image processing apparatus 100 may obtain the original tooth 210 having the same shape as the resultant tooth 310 that has been modified on the basis of the user input.

For example, the intraoral image processing apparatus 100 may control the display 130 to display the modified original model 200 and the modified resultant model 300 together. For example, the intraoral image processing apparatus 100 may modify the original model 200 in real time while the resultant model 300 is being modified. For example, the intraoral image processing apparatus 100 may synchronize the original model 200 and the resultant model 300. Also, for example, the intraoral image processing apparatus 100 may modify the original model 200 on the basis of release of the user input that modifies the resultant model 300.

FIG. 8A is a view for explaining a relationship between the teeth of the original model 200 and the teeth of the resultant model 300, according to an embodiment.

Referring to FIG. 8A, when the shape of one of the original tooth 210 and the resultant tooth 310 is modified, the intraoral image processing apparatus 100 according to an embodiment may modify the shape of the other one to the same shape.

In operation S805, the intraoral image processing apparatus 100 according to an embodiment may obtain the resultant tooth 310 of the resultant model 300 that is moved according to a linear transformation applied to the original tooth 210 included in the original model 200. Operation S805 may correspond to operation S605 of FIG. 6A.

For example, each of the individual teeth 211 and 212 (or referred to as a first original tooth 211 and a second original tooth 212) included in the original tooth 210 may be moved to desired positions on the basis of transformation matrices T1 and T2 (or referred to as a first transformation matrix T1 and a second transformation matrix T2) having different transformation components. For example, the first original tooth 211 may be transformed into a first resultant tooth 311 on the basis of the first transformation matrix T1. For example, the second original tooth 212 may be transformed into a second resultant tooth 312 on the basis of the second transformation matrix T2. The first transformation matrix T1 and the second transformation matrix T2 may have different transformation components. Accordingly, the amounts of movements of individual teeth may be different from each other.

In operation S815, the intraoral image processing apparatus 100 according to an embodiment may modify the shape of the resultant tooth 310 on the basis of a user input. The intraoral image processing apparatus 100 according to an embodiment may generate a replicated tooth 810 by replicating the modified resultant tooth 310.

For example, the intraoral image processing apparatus 100 may reduce the size of the mesh of or remove the number of meshes from a region 801, through which the brush icon 480 has passed, in a state in which a shape removing function is selected. For example, the intraoral image processing apparatus 100 may obtain the first resultant tooth 311 in which a shape has been removed from the region 801.

For example, the intraoral image processing apparatus 100 may generate the replicated tooth 810 having the same shape as the first resultant tooth 311 in which the shape has been removed from the region 801. For example, the intraoral image processing apparatus 100 may replicate only a specific tooth of which the shape has been modified. For example, the intraoral image processing apparatus 100 may replicate the first resultant tooth 311 and may not replicate the second resultant tooth 312 of which the shape has not been modified. Also, the replicated tooth 810 may not be displayed on the intraoral image processing apparatus 100, but the embodiment is not limited thereto.

In operation S825, the intraoral image processing apparatus 100 according to an embodiment may obtain the modified original tooth 210 by moving the modified resultant tooth 310 according to the inverse-linear transformation. For example, the intraoral image processing apparatus 100 may obtain the first original tooth 211, of which the coordinates are moved by applying an inverse-transformation matrix T-1 to the replicated tooth 810. For example, the intraoral image processing apparatus 100 may apply the inverse-transformation matrix T-1 to the replicated tooth 810, which has been formed by replicating the modified first resultant tooth 311, and thus obtain the first original tooth 211.

In an embodiment, the intraoral image processing apparatus 100 may obtain the first original tooth 211 of which a region 802 corresponding to the region 801 of the first resultant tooth 311 is modified. For example, the intraoral image processing apparatus 100 may obtain the first original tooth 211 in which a shape has been removed from the region 802. For example, the intraoral image processing apparatus 100 may obtain the first original tooth 211 having the shape synchronized with that of the first resultant tooth 311.

FIG. 8B is a view for explaining a relationship between the teeth of the original model 200 and the teeth of the resultant model 300, according to an embodiment.

Referring to FIG. 8B, when replicating the resultant tooth 310, the intraoral image processing apparatus 100 according to an embodiment replicates not only the first resultant tooth 311 of which the shape has been modified, but also the remaining teeth (e.g., the second resultant tooth 312) of which the shape has not been modified. For this reason, the embodiment of FIG. 8B is different from the embodiment of FIG. 8A. For example, the intraoral image processing apparatus 100 may generate a replicated model 800 and replicated teeth 811 and 812 that have the same shape as the resultant tooth 310. Hereinafter, a description focuses on differences from FIG. 8A.

In operation S835, the intraoral image processing apparatus 100 according to an embodiment may generate the replicated model 800, which is formed by replicating the resultant tooth 310, on the basis of the resultant tooth 310 of which the shape has been modified. For example, the replicated model 800 may include the teeth 811 and 812 respectively formed by replicating the first resultant tooth 311 and the second resultant tooth 312.

In operation S845, the intraoral image processing apparatus 100 according to an embodiment may apply the inverse-transformation matrix T-1 to the replicated model 800 so as to obtain the original tooth 210 of which the coordinates have been moved. For example, the intraoral image processing apparatus 100 may obtain the first original tooth 211 and the second original tooth 212.

Hereinafter, a process, in which the intraoral image processing apparatus 100 according to an embodiment modifies the resultant gingiva 320 on the basis of the modification of the original gingiva 220, is described with reference to FIGS. 9 to 12.

FIG. 9 is a view for explaining a relationship between the gingiva of the original model 200 and the gingiva of the resultant model 300, according to an embodiment.

Referring to FIG. 9, in the intraoral image processing apparatus 100 according to an embodiment, the original gingiva 220 of the original model 200 and the resultant gingiva 320 of the resultant model 300 have different shapes. However, the relationship therebetween that is modified based on the movement of the teeth may remain the same. The resultant gingiva 320 may have a shape that is naturally modified according to the movement of the teeth of the original gingiva 220.

In operation S910, the intraoral image processing apparatus 100 according to an embodiment may obtain the resultant gingiva 320 having a shape that is modified by reflecting an amount of tooth movement 900 (hereinafter, referred to as a tooth movement amount) in the original gingiva 220.

For example, the tooth movement amount 900 may be determined according to transformation components (e.g., displacement transformation components, rotation transformation components, etc.) of the transformation matrix T that moves each of individual teeth. For example, the tooth movement amount 900 may be determined according to x-axis, y-axis, and z-axis transformation components that represent the movements of the teeth. For example, a first tooth included in the original tooth 210 may be moved to a desired position on the basis of a first transformation matrix T1, and thus, the first tooth included in the resultant tooth 310 may be obtained. For example, a second tooth, a third tooth, and a fourth tooth included in the original tooth 210 may be moved to desired positions on the basis of a second transformation matrix T2, a third transformation matrix T3, and a fourth transformation matrix T4, respectively, and thus, the second tooth, the third tooth, and the fourth tooth included in the resultant tooth 310 may be obtained.

For example, the intraoral image processing apparatus 100 may obtain the resultant tooth 310 by reflecting the tooth movement amount 900 in the original tooth 210 and may obtain the resultant gingiva 320 by reflecting the tooth movement amount 900 in the original gingiva 220. For example, the original gingiva 220 may be morphed by the x-axis, y-axis, and z-axis displacements of the tooth movement amount 900. For example, the original gingiva 220 may be morphed and modified into the resultant gingiva 320.

In the intraoral image processing apparatus 100 according to an embodiment, the number of polygonal meshes included in the mesh data of the original gingiva 220 may be same as the number of polygonal meshes included in the mesh data of the resultant gingiva 320. For example, the positions or normal directions of the polygonal meshes of the original gingiva 220 may be different from the positions or normal directions of the polygonal meshes of the resultant gingiva 320.

In the intraoral image processing apparatus 100 according to an embodiment, the shape of one of the original gingiva 220 and the resultant gingiva 320 may be modified. Also, even after this modification, the original gingiva 220 and the resultant gingiva 320 need to maintain the relationship therebetween that is modified based on the movement of the teeth. The intraoral image processing apparatus 100 according to an embodiment may maintain the relationship between the original gingiva 220 and the resultant gingiva 320 by performing operations S920, S930, and S940.

In operation S920, the intraoral image processing apparatus 100 according to an embodiment may modify the shape of the original gingiva 220 included in the original model 200 on the basis of a user input.

In operation S930, the intraoral image processing apparatus 100 according to an embodiment may modify the shape of the resultant gingiva 320 by reflecting the tooth movement amount 900 in the modified original gingiva 220. In operation S940, the intraoral image processing apparatus 100 according to an embodiment may obtain the modified resultant gingiva 320. Also, for example, the intraoral image processing apparatus 100 may replicate the modified original gingiva 220 and then reflect the tooth movement amount 900 in the replicated gingiva to obtain the resultant gingiva 320.

In the intraoral image processing apparatus 100 according to an embodiment, the original gingiva 220 and the resultant gingiva 320 may maintain the relationship therebetween that is modified on the basis of the movement of the teeth, even after modification according to the user input. Even after the modification according to the user input, the original gingiva 220 and the resultant gingiva 320 may include the same number of polygonal meshes, and the connection relationship between the polygonal meshes may remain the same.

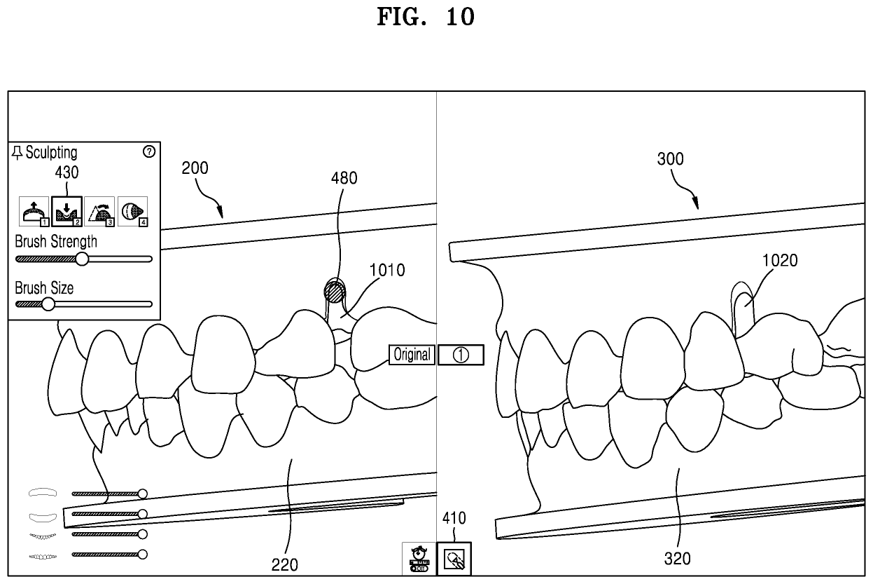

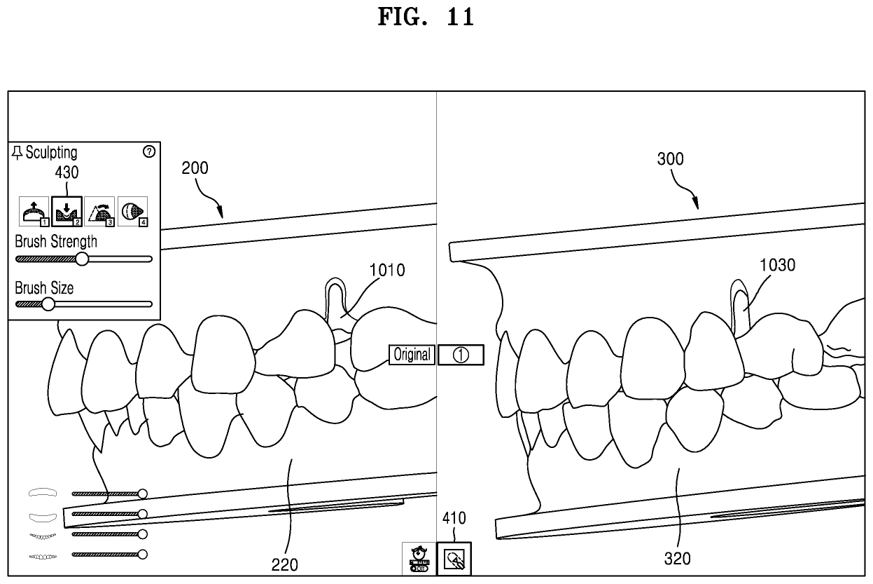

FIGS. 10 and 11 are views illustrating an operation of obtaining the gingivae of the resultant model 300 that are modified as the gingivae of the original model 200 are modified by the intraoral image processing apparatus according to an embodiment. FIG. 10 illustrates a screen on which a user input is continuously applied, and FIG. 11 illustrates a screen from which the user input has been released.

Referring to FIG. 10, the intraoral image processing apparatus 100 according to an embodiment may obtain a user input that modifies the shape of the original gingiva 220 of the original model 200. The intraoral image processing apparatus 100 may modify the shape of the original gingiva 220 on the basis of the user input. The intraoral image processing apparatus 100 may obtain the resultant gingiva 320 that is modified based on the modified original gingiva 220.

For example, the intraoral image processing apparatus 100 may obtain a user input for dragging the brush icon 480 in a state in which the second menu item 430 is selected. For example, the intraoral image processing apparatus 100 may remove a shape from a region through which the brush icon 480 passes. For example, the intraoral image processing apparatus 100 may decrease the size of the mesh of or remove the number of meshes from the outer surface of the original gingiva 220 corresponding to a region 1010, through which the brush icon 480 has passed, and may thus sculpt the shape of the original gingiva 220 to be recessed inward.

For example, the intraoral image processing apparatus 100 may remove a shape of the outer surface of the resultant gingiva 320 having the same position information as the original gingiva 220 corresponding to the region 1010 through which the brush icon 480 has passed. For example, the intraoral image processing apparatus 100 may reduce the size of the mesh of or remove the number of meshes from a region 1020 of the resultant gingiva 320 even if there is no separate user input to the resultant gingiva 320.

For example, the region 1010 of the original gingiva 220 and the region 1020 of the resultant gingiva 320 may have the same position information. For example, the region 1010 of the original gingiva 220 and the region 1020 of the resultant gingiva 320 may have the same or different shape information.

Referring to FIG. 11, the intraoral image processing apparatus 100 according to an embodiment may obtain the modified resultant gingiva 320, on the basis of release of the user input. For example, the shape of the region 1020 of the resultant gingiva 320 displayed on the screen when the user input is continuing as in FIG. 10 may be different from the shape of a region 1030 of the resultant gingiva 320 displayed on the screen when the user input is released as in FIG. 11. However, the embodiment is not limited thereto, and the shape of the region 1020 may be same as the shape of the region 1030.

Also, the shape of the region 1010 of the original gingiva 220 and the shape of the region 1030 of the resultant gingiva 320 may be different from each other. However, the embodiment is not limited thereto, and the shape of the region 1010 may be same as the shape of the region 1030.

After the user input is released, the intraoral image processing apparatus 100 according to an embodiment may reflect the tooth movement amount 900 in the original gingiva 220 which has been modified.

The intraoral image processing apparatus 100 according to an embodiment may synchronize the shape deformation of the original model 200 and the shape deformation of the resultant model 300. When the shape of any one of the original model 200 and the resultant model 300 is modified, the intraoral image processing apparatus 100 according to an embodiment may automatically reflect the modified shape in the other one.

Hereinafter, a process, in which the intraoral image processing apparatus 100 according to an embodiment modifies the original gingiva 220 on the basis of the modification of the resultant gingiva 320, is described with reference to FIGS. 12 to 14.

FIG. 12 is a view for explaining a relationship between the gingiva of the original model 200 and the gingiva of the resultant model 300, according to an embodiment.

Referring to FIG. 12, in the intraoral image processing apparatus 100 according to an embodiment, the original gingiva 220 of the original model 200 and the resultant gingiva 320 of the resultant model 300 have different shapes. However, the relationship therebetween that is modified based on the movement of the teeth may remain the same. The resultant gingiva 320 may have a shape that is naturally modified according to the movement of the teeth of the original gingiva 220.

In operation S1210, the intraoral image processing apparatus 100 according to an embodiment may obtain the resultant gingiva 320 having a shape that is modified by reflecting a tooth movement amount 900 in the original gingiva 220. Operation S1210 may correspond to operation S910 of FIG. 9.

In the intraoral image processing apparatus 100 according to an embodiment, the shape of one of the original gingiva 220 and the resultant gingiva 320 may be modified. Also, even after this modification, the original gingiva 220 and the resultant gingiva 320 need to maintain the relationship therebetween that is modified based on the movement of the teeth. The intraoral image processing apparatus 100 according to an embodiment may maintain the relationship between the original gingiva 220 and the resultant gingiva 320 by performing operations S1220, S1230, S1240, and S1250.

In operation S1220, the intraoral image processing apparatus 100 according to an embodiment may primarily modify the shape of the resultant gingiva 320 included in the resultant model 300 on the basis of a user input.

The intraoral image processing apparatus 100 according to an embodiment may obtain the position information of the resultant gingiva 320 on the basis of the user input. For example, the position information of the resultant gingiva 320 on the basis of the user input may include the information about a user input point 1201 at which the user input exists in a mesh data 350 and the Information about a specific mesh which includes the user input point 1201. For example, the intraoral image processing apparatus 100 may convert a screen point, which is input on the display 130 by a user, into the user input point 1201 (or a seed point), which is the point in contact with the mesh data 350 of the resultant gingiva 320. For example, based on the screen point, the intraoral image processing apparatus 100 may obtain the user input point 1201 at which a straight line in the screen normal direction meets the mesh data 350 of the resultant gingiva 320. For example, the intraoral image processing apparatus 100 may identify an identification number or a mesh ID that relates to the mesh in which the user input point 1201 is located. For example, the intraoral image processing apparatus 100 may give the mesh including the user input point 1201 with a mesh identification number called a 5th triangular mesh.

The intraoral image processing apparatus 100 according to an embodiment may obtain the coordinates of the user input point 1201 using the barycentric coordinate system. For example, the intraoral image processing apparatus 100 may obtain the coordinates of an arbitrary point inside the triangular mesh through the barycentric coordinate system. The description thereof is given above with reference to FIG. 4.

The intraoral image processing apparatus 100 according to an embodiment may obtain a normal vector 1202 of the triangular mesh on the basis of the coordinates of the user input point 1201. The intraoral image processing apparatus 100 according to an embodiment may primarily modify the shape of the resultant gingiva 320 on the basis of the direction of the normal vector 1202. For example, the intraoral image processing apparatus 100 may perform a shape adding function or a shape removing function by moving the positions of vertices of the triangular mesh in the direction of the normal vector 1202.

In operation S1230, the intraoral image processing apparatus 100 according to an embodiment may modify the shape of the original gingiva 220 on the basis of the primarily modified resultant gingiva 320.

For example, the intraoral image processing apparatus 100 may obtain the same position information as the resultant gingiva 320 that has primarily been modified, and may modify the shape of the original gingiva 220 at the same position. For example, the intraoral image processing apparatus 100 may obtain the position of the user input point 1201, an identification number for a specific mesh including the user input point 1201, and the like, as the position information of the resultant gingiva 320 that is primarily modified.

The intraoral image processing apparatus 100 according to an embodiment may obtain a target point 1203 of the original gingiva 220, corresponding to the user input point 1201 of the resultant gingiva 320 that is primarily modified. The intraoral image processing apparatus 100 may obtain a normal vector 1204 for the target point 1203 of the original gingiva 220. The intraoral image processing apparatus 100 according to an embodiment may identify a mesh of the original gingiva 220 which has an identification number equal to that of a specific mesh including the user input point 1201 of the resultant gingiva 320 that is primarily modified. For example, the intraoral image processing apparatus 100 may obtain the position information of a 5th triangular mesh of the original gingiva 220, corresponding to the 5th triangular mesh of the resultant gingiva 320.

On the basis of the position information of the resultant gingiva 320 in which there has been a user input, the intraoral image processing apparatus 100 according to an embodiment may automatically modify the shape of the original gingiva 220 at the same position. For example, the intraoral image processing apparatus 100 may move the positions of the vertices of the triangular mesh in the direction of the normal vector 1204 of the target point 1203 in the 5th triangular mesh and thus automatically add a shape to or automatically remove a shape from the original gingiva 220. For example, the intraoral image processing apparatus 100 may obtain the original gingiva 220 that is formed by automatically reflecting the primarily modified shape of the resultant gingiva 320.

In an embodiment, mesh data 250 of the original gingiva 220 and the mesh data 350 of the resultant gingiva 320 may maintain the same number of triangular meshes, but the positions or normal directions of the triangular meshes may be different from each other. For example, the connection relationship between the triangular meshes of the user input point 1201 and the connection relationship between the triangular meshes of the target point 1203 may be the same. For example, the direction of the normal vector 1202 of the user input point 1201 and the direction of the normal vector 1204 of the target point 1203 may be different from each other. However, the embodiment is not limited thereto. For example, the direction of the normal vector 1202 of the user input point 1201 and the direction of the normal vector 1204 of the target point 1203 may be the same.

In operation S1240, the intraoral image processing apparatus 100 according to an embodiment may secondarily modify the resultant gingiva 320 by reflecting the tooth movement amount 900 in the modified original gingiva 220.

In operation S1250, the intraoral image processing apparatus 100 according to an embodiment may obtain the secondarily modified resultant gingiva 320. For example, the intraoral image processing apparatus 100 may maintain the morphing relationship between the original gingiva 220 and the resultant gingiva 320.

In the intraoral image processing apparatus 100 according to an embodiment, the original gingiva 220 and the resultant gingiva 320 may maintain the relationship therebetween that is modified on the basis of the movement of the teeth, even after modification according to the user input. Even after the modification according to the user input, the original gingiva 220 and the resultant gingiva 320 may include the same number of polygonal meshes, and the connection relationship between the polygonal meshes may remain the same.

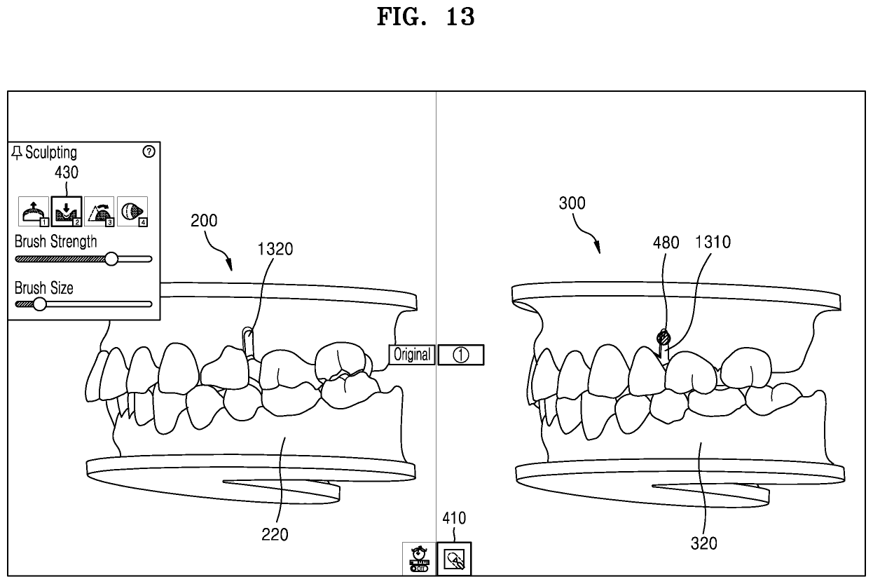

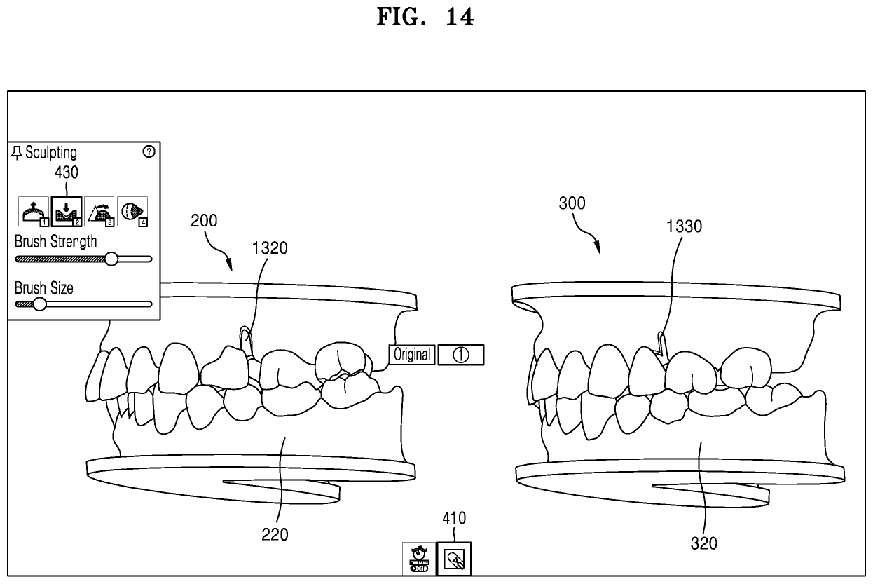

FIGS. 13 and 14 are views illustrating an operation of obtaining the gingivae of the original model 200 that are modified as the gingivae of the resultant model 300 are modified by the intraoral image processing apparatus according to an embodiment. FIG. 13 illustrates a screen on which a user input is continuously applied, and FIG. 14 illustrates a screen from which the user input has been released. The shape of a region 1310 of the resultant gingiva 320 which is primarily modified in FIG. 13 may be different from the shape of a region 1330 of the resultant gingiva 320 which is secondarily modified in FIG. 14.

Referring to FIG. 13, the intraoral image processing apparatus 100 according to an embodiment may obtain a user input that modifies the shape of the resultant gingiva 320 of the resultant model 300. The intraoral image processing apparatus 100 may primarily modify the shape of the resultant gingiva 320 on the basis of the user input. The intraoral image processing apparatus 100 may obtain the original gingiva 220 that is modified based on the primarily modified resultant gingiva 320.

For example, the intraoral image processing apparatus 100 may obtain a user input for dragging the brush icon 480 in a state in which the second menu item 430 is selected. For example, the intraoral image processing apparatus 100 may remove a shape from a region through which the brush icon 480 passes. For example, the intraoral image processing apparatus 100 may reduce the size of the mesh of or remove the number of meshes from the outer surface of the resultant gingiva 320 corresponding to a region 1310, through which the brush icon 480 has passed.

For example, the intraoral image processing apparatus 100 may reduce the size of the mesh of or remove the number of meshes from the outer surface of the original gingiva 220 having the same position information as the resultant gingiva 320 corresponding to the region 1310, through which the brush icon 480 has passed. For example, the intraoral image processing apparatus 100 may remove a shape from a region 1320 of the original gingiva 220 even if there is no separate user input to the original gingiva 220.

For example, the region 1320 of the original gingiva 220 and the region 1310 of the resultant gingiva 320 may have the same position information. For example, the mesh identification number of the mesh belonging to the region 1320 of the original gingiva 220 may be same as the mesh identification number of the mesh belonging to the region 1310 of the resultant gingiva 320. For example, the region 1320 of the original gingiva 220 and the region 1310 of the resultant gingiva 320 may have different shape information. However, the embodiment is not limited thereto, and the region 1320 and the region 1310 may have the same shape information.

Referring to FIG. 14, the intraoral image processing apparatus 100 according to an embodiment may obtain the secondarily modified resultant gingiva 320, on the basis of release of the user input. In an embodiment, the region 1310 of the resultant gingiva 320 primarily modified on the basis of the user input and the region 1330 of the resultant gingiva 320 secondarily modified by reflecting the tooth movement amount 900 in the modified original gingiva 220 may have different shapes.

For example, the shape of the region 1310 of the resultant gingiva 320 displayed on the screen when the user input is continuing as in FIG. 13 may be different from the shape of a region 1330 of the resultant gingiva 320 displayed on the screen when the user input is released as in FIG. 14. However, the embodiment is not limited thereto, and the shape of the region 1310 may be same as the shape of the region 1330.

Also, in an embodiment, the shape of the region 1320 of the original gingiva 220 and the shape of the region 1330 of the resultant gingiva 320 may be different from each other. However, the embodiment is not limited thereto, and the shape of the region 1320 may be same as the shape of the region 1330.

After the user input is released, the intraoral image processing apparatus 100 according to an embodiment may reflect the tooth movement amount 900 in the modified original gingiva 220 and may thus obtain the secondarily modified resultant gingiva 320.

The intraoral image processing apparatus 100 according to an embodiment may synchronize the shape deformation of the original model 200 and the shape deformation of the resultant model 300. When the shape of any one of the original model 200 and the resultant model 300 is modified, the intraoral image processing apparatus 100 according to an embodiment may automatically reflect the modified shape in the other one.

FIG. 15 is a view showing orthodontic simulations depending on a plurality of scenarios according to an embodiment.

Referring to FIG. 15, the intraoral image processing apparatus 100 according to an embodiment may provide orthodontic simulations depending on a plurality of scenarios according to an embodiment. For example, the intraoral image processing apparatus 100 may provide a 3D intraoral model before an orthodontic correction and a 3D intraoral model predicted after the orthodontic correction and may predict various intraoral models according to various scenarios, considering the presence or absence of artificial structures that may be inserted into the oral cavity, the types of artificial structures, whether the teeth are extracted or not, the periods of orthodontic correction, and the like. The intraoral image processing apparatus 100 may display various predicted teeth states after the orthodontic correction through the plurality of scenarios, and accordingly, a patient may predict how the state of his or her teeth changes due to a certain process of orthodontic corrections.

For example, the intraoral image processing apparatus 100 may provide a plurality of resultant models which are predicted from an original model 200, respectively, according to the plurality of scenarios. For example, the intraoral image processing apparatus 100 may provide a first resultant model 2100 predicted from the original model 200 according to a first scenario, a second resultant model 2200 predicted according to a second scenario, and a third resultant model 2300 predicted according to a third scenario. The number of scenarios may be determined depending on user settings, but the embodiment is not limited thereto. Here, the resultant model 300 described above may correspond to the first resultant model 2100 according to the first scenario.

The intraoral image processing apparatus 100 according to an embodiment may display a scenario menu 1510 that shows a plurality of scenarios on a screen. For example, a user may manipulate the 3D intraoral model by selecting one of an original menu, a first scenario menu, a second scenario menu, and a third scenario menu which are included in the scenario menu 1510. For example, the intraoral image processing apparatus 100 may manipulate the first resultant model 2100 on the basis of a user input of selecting the first scenario menu in the scenario menu 1510. For example, a sculpting function for the first resultant model 2100 may be activated.

The intraoral image processing apparatus 100 according to an embodiment may obtain the first resultant model 2100, the second resultant model 2200, and the third resultant model 2300 for an object, from the original model 200. For example, the first resultant model 2100 may include a first resultant tooth 2110 that moves from an original tooth 210 and a first resultant gingiva 2120 that is modified from an original gingiva 220. For example, the second resultant model 2200 may include a second resultant tooth 2210 that moves from the original tooth 210 and a second resultant gingiva 2220 that is modified from the original gingiva 220. For example, the third resultant model 2300 may include a third resultant tooth 2310 that moves from the original tooth 210 and a third resultant gingiva 2320 that is modified from the original gingiva 220.

The intraoral image processing apparatus 100 according to an embodiment may modify the shape of one of the original model 200 and the plurality of resultant models 2100, 2200, and 2300, on the basis of the user input. For example, the intraoral image processing apparatus 100 may modify mesh data for intraoral images using sculpting functions.

The intraoral image processing apparatus 100 according to an embodiment may modify shapes of the other models among the original model 200 and the plurality of resultant models 2100, 2200, and 2300, on the basis of the modified shape. When one shape is modified, the intraoral image processing apparatus 100 according to an embodiment may reflect the modified shape in all the other models.

For example, the intraoral image processing apparatus 100 may receive a user input that modifies the original gingiva 220 of the original model 200. The intraoral image processing apparatus 100 may modify the original model 200 on the basis of the user input. The intraoral image processing apparatus 100 may modify the first resultant model 2100, the second resultant model 2200, and the third resultant model 2300 on the basis of the modified original model 200. In this case, as shown in FIGS. 9 to 11, the intraoral image processing apparatus 100 may synchronize the original model 200 with each of the first resultant model 2100, the second resultant model 2200, and the third resultant model 2300.

For example, a region 1501 of the original gingiva 220 may have a recessed shape on the basis of a user input. For example, the intraoral image processing apparatus 100 may modify the first resultant gingiva 2120 of the first resultant model 2100 that has the same position information as the region 1501 from which a shape has been removed. The first resultant gingiva 2120 may have a region 1502 from which a shape is removed, even if there is no user input. Also, the intraoral image processing apparatus 100 may modify a region 1503 of the second resultant model 2200 and a region 1504 of the third resultant model 2300, which have the same position information as the region 1501 from which the shape has been removed.

Also, for example, the intraoral image processing apparatus 100 may receive a user input that modifies the first resultant gingiva 2120 of the first resultant model 2100. The intraoral image processing apparatus 100 may primarily modify the shape of the first resultant model 2100 on the basis of the user input. The intraoral image processing apparatus 100 may modify the original model 200 on the basis of the primarily modified first resultant model 2100. Also, the intraoral image processing apparatus 100 may secondarily modify the first resultant model 2100 on the basis of the modified original model 200. Also, the intraoral image processing apparatus 100 may modify the second resultant model 2200 and the third resultant model 2300 on the basis of the modified original model 200. In this case, as shown in FIGS. 12 to 14, the intraoral image processing apparatus 100 may synchronize the original model 200 with each of the first resultant model 2100, the second resultant model 2200, and the third resultant model 2300.

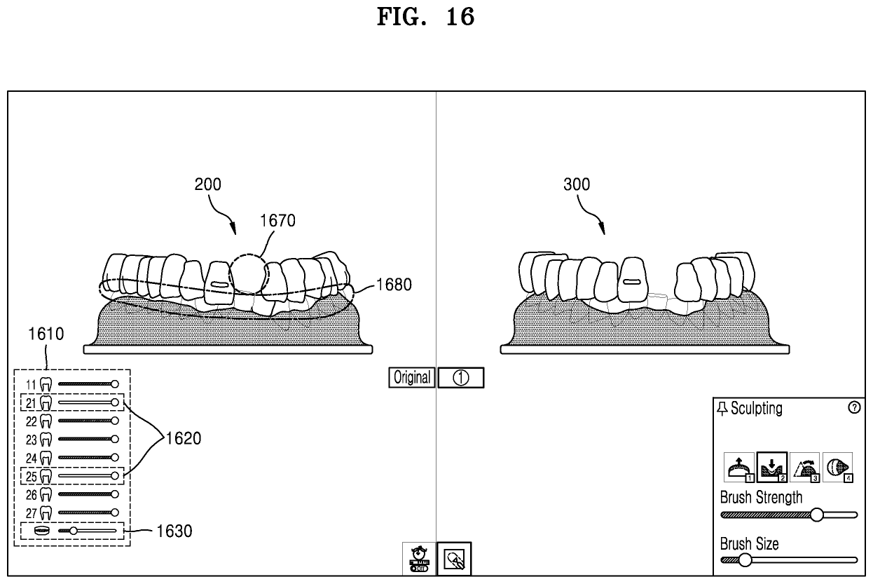

FIG. 16 is a view showing an original model 200 and a resultant model 300 in an intraoral image processing apparatus 100 according to an embodiment.

Referring to FIG. 16, the intraoral image processing apparatus 100 according to an embodiment may provide functions of hiding the gingivae or teeth or setting transparency of the gingivae or teeth. The intraoral image processing apparatus 100 may display, on a screen, a transparency setting menu 1610 corresponding to the transparency setting function. The transparency setting menu 1610 may include tooth numbers assigned to the respective teeth and scrolls for adjusting the transparency for the respective tooth numbers. The transparency setting menu 1610 may include a scroll capable of adjusting the transparency of the gingiva.

For example, the intraoral image processing apparatus 100 may assign a number to each of the teeth of an object. For example, each of the teeth is given a tooth number that distinguishes the upper and lower jaws. Also, each of the teeth is given a tooth number, such as 1st, 2nd, etc., starting from the left.

The intraoral image processing apparatus 100 may adjust the transparency of each of the teeth on the basis of a user input that adjusts the scroll left and right for each of tooth numbers. For example, the intraoral image processing apparatus 100 may hide the 21st and 25th teeth 1670 on the basis of a user input that deactivates scrolls 1620 of the 21st and 25th teeth. Also, for example, the intraoral image processing apparatus 100 may set lower jaw teeth 1680 to be transparent, on the basis of a user input that moves a scroll 1630 of the lower jaw teeth to the left. For example, on the basis that scrolls are located at right ends, the intraoral image processing apparatus 100 may set the other teeth (e.g., 11th, 22nd, 23rd, 24th, 26th, and 27th teeth) to be opaque.

The intraoral image processing apparatus 100 allows a user to hide the gingivae or teeth or arbitrarily set the transparency of the gingivae or teeth, and thus, regions of interest to the user may be highlighted. The intraoral image processing apparatus 100 highlights the teeth or gingivae of interest to the user, and thus, the user may easily sculpt desired regions.

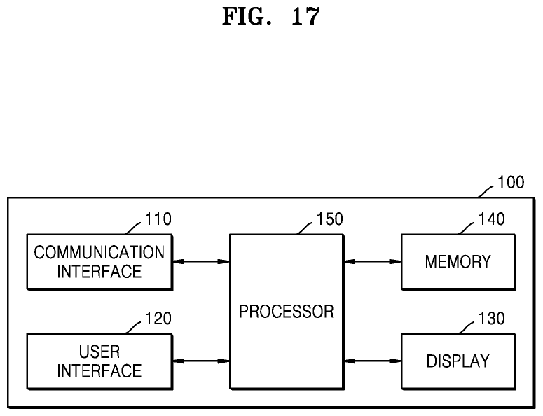

FIG. 17 is a block diagram of an intraoral image processing apparatus 100 according to an embodiment.

Referring to FIG. 17, the intraoral image processing apparatus 100 may include a communication interface 110, a user interface 120, a display 130, memory 140, and a processor 150.

The communication interface 110 may communicate with at least one external electronic device (e.g., a 3D scanner 10, a server, or an external medical device) via a wired or wireless communication network. The communication interface 110 may communicate with at least one external electronic device under the control of the processor 150.

Specifically, the communication interface 110 may include at least one short-distance communication module, which performs communication according to communication standards, such as Bluetooth, Wi-Fi, Bluetooth low energy (BLE), near field communication/radio frequency identification (NFC/RFID), Wifi direct, Ultra-wideband (UWB), or ZigBee.

Also, the communication interface 110 may further include a long-distance communication module, which communicates with a server for supporting long-distance communication according to long-distance communication standards. Specifically, the communication interface 110 may include a long-distance communication module that performs communication via a network for Internet communication. Also, the communication interface 110 may include a long-distance communication module that performs communication via a communication network conforming to communication standards, such as 3rd generation (3G), 4th generation (4G), and/or 5th generation (5G) communication standards.

Also, in order to communicate by wire with an external electronic device (e.g., the 3D scanner 10, etc.), the communication interface 110 may include at least one port that is connected to the external electronic device via a wired cable. Accordingly, the communication interface 110 may communicate with the external electronic device that is wired via the at least one port.

The user interface 120 may receive a user input for controlling the intraoral image processing apparatus 100. The user interface 120 may include, but not limited to, user input devices, such as a touch panel for sensing a touch of a user, a button for receiving a push operation from a user, and a mouse or keyboard for designating or selecting a point on a user interface screen.

Also, the user interface 120 may include a voice recognition device for recognizing voice. For example, the voice recognition device may include a microphone, and the voice recognition device may receive a voice command or voice request of a user. Accordingly, the processor 150 may perform control so that an operation corresponding to the voice command or voice request is carried out.

The display 130 displays a screen. Specifically, the display 130 may display a certain screen under the control of the processor 150. Specifically, the display 130 may display a user interface screen that includes an intraoral image generated based on data obtained by scanning the oral cavity of a patient with the 3D scanner 10. Also, the display 130 may display a user interface screen that includes information about the dental treatment of a patient.

The memory 140 may store at least one instruction. Also, the memory 140 may store at least one instruction executed by the processor 150. Also, the memory 140 may store at least one program executed by the processor 150. Also, the memory 140 may store data which is received from the 3D scanner 10 (e.g., raw data obtained by scanning the oral cavity, etc.). Also, the memory 140 may store the intraoral image three-dimensionally representing the oral cavity.

The processor 150 executes at least one instruction stored in the memory 140 and performs control so that the intended operation is carried out. Here, at least one instruction may be stored in an internal memory included in the processor 150 or in the memory 140 included in a data processing device separate from the processor 150.

Specifically, the processor 150 may execute at least one instruction and control at least one component included in a data processing device so that the intended operation is performed. Accordingly, even if the case in which the processor performs certain operations is used as an example, the above-described control may mean that the processor controls at least one component included in the data processing device so that certain operations are performed.

The processor 150 according to an embodiment executes one or more instructions stored in the memory 140. Accordingly, an original model 200 and a resultant model 300 for an object may be obtained, the shape of one of the original model 200 and the resultant model 300 may be modified on the basis of an user input, and the shape of the other one of the original model 200 and the resultant model 300 may be modified on the basis of the modified shape.

The processor 150 according to an embodiment executes one or more instructions stored in the memory 140. Accordingly, while one of the original model 200 and the resultant model 300 is modified, the other one of the original model 200 and the resultant model 300 may be modified.

The processor 150 according to an embodiment executes one or more instructions stored in the memory 140. Accordingly, the original model 200 or the resultant model 300 in which there has been no user input may be modified.

The processor 150 according to an embodiment executes one or more instructions stored in the memory 140. Accordingly, it is possible to perform any one of the following operations: sculpting the shape of the object convexly, sculpting the shape of the object concavely, smoothing the shape of the object, and morphing the shape of the object.

The processor 150 according to an embodiment executes one or more instructions stored in the memory 140. Accordingly, the shape of the teeth for one of the original model 200 and the resultant model 300 may be modified based on a user input, and the shape of the teeth for the other one of the original model 200 and the resultant model 300 may be modified based on the modified shape of the teeth. The shape of the original tooth 210 of the original model 200 is same as the shape of the resultant tooth 310 of the resultant model 300.

The processor 150 according to an embodiment executes one or more instructions stored in the memory 140. Accordingly, it is possible to obtain the resultant tooth 310 of the resultant model 300 that is moved according to a linear transformation applied to the original tooth 210 included in the original model 200. Also, the shape of the original tooth 210 may be modified based on a user input, and the modified resultant tooth 310 may be obtained by moving the modified original tooth 210 according to the linear transformation.

The processor 150 according to an embodiment executes one or more instructions stored in the memory 140. Accordingly, it is possible to obtain the resultant tooth 310 of the resultant model 300 including the resultant tooth 310 that is moved according to a linear transformation applied to the original tooth 210 included in the original model 200. Also, the shape of the resultant tooth 310 may be modified based on a user input, and the modified original tooth 210 may be obtained by moving the modified resultant tooth 310 according to the inverse-linear transformation.

The processor 150 according to an embodiment executes one or more instructions stored in the memory 140. Accordingly, the shape of the gingivae for one of the original model 200 and the resultant model 300 may be modified based on a user input, and the shape of the gingivae for the other one of the original model 200 and the resultant model 300 may be modified based on the modified shape of the gingivae. The shape of a resultant gingiva 320 of the resultant model 300 may be modified by reflecting the movement of the teeth in the shape of an original gingiva 220 of the original model 200.

The processor 150 according to an embodiment executes one or more instructions stored in the memory 140. Accordingly, it is possible to obtain the resultant model 300 having the resultant gingiva 320 that is modified by reflecting an amount of tooth movement in the original gingiva 220 of the original model 200. Also, the shape of the original gingiva 220 may be modified based on a user input, and the shape of the resultant gingiva 320 may be modified by reflecting the amount of tooth movement in the modified original gingiva 220.

The processor 150 according to an embodiment executes one or more instructions stored in the memory 140. Accordingly, it is possible to obtain the resultant model 300 having the resultant gingiva 320 that is modified by reflecting an amount of tooth movement in the original gingiva 220 of the original model 200. Also, the shape of the resultant gingiva 320 may be primarily modified based on a user input, the shape of the original gingiva 220 may be modified based on the primarily modified resultant gingiva 320, and the shape of the resultant gingiva 320 may be secondarily modified by reflecting the amount of tooth movement in the modified original gingiva 220.

The processor 150 according to an embodiment executes one or more instructions stored in the memory 140. Accordingly, a target point of the original gingiva 220 may be obtained corresponding to a user input point of the primarily modified resultant gingiva 320, and it is possible to modify the original gingiva 220 on the basis of a normal vector direction for the target point of the original gingiva 220.

The processor 150 according to an embodiment executes one or more instructions stored in the memory 140. Accordingly, the shape of the resultant gingiva 320 may be modified or secondarily modified on the basis of release of the user input.

The processor 150 according to an embodiment executes one or more instructions stored in the memory 140. Accordingly, it is possible to obtain a plurality of resultant models for the object. Also, the shape of one among the original model and the plurality of resultant models may be modified based on a user input, and the shapes of the other models among the original model and the plurality of resultant models may be modified based on the modified shape. For example, the processor 150 may obtains a first resultant model 2100 and a second resultant model 2200 for the object. Also, the first resultant model 2100 is primarily modified based on a user input, and the original model 200 may be modified based on the modified first resultant model 2100. The first resultant model 2100 may be secondarily modified based on the modified original model 200, and the second resultant model 2200 may be modified.

The processor 150 according to an embodiment may be in the form of including at least one internal processor therein and a memory element (e.g., random access memory (RAM), read only memory (ROM), etc.) for storing at least one of programs, instructions, signals, and data to be processed or used in the internal processor.

Also, the processor 150 may include a graphics processing unit (GPU) for graphics processing corresponding to video. Also, the processor 150 may be provided as a system on chip (SoC) in which a core and GPU are integrated. Furthermore, the processor 150 may include a multi core more than a single core. For example, the processor 150 may include a dual core, a triple core, a quad core, a hexa core, an octa core, a deca core, a dodeca core, a hexa-decimal core, etc.

In an embodiment, the processor 150 may generate an intraoral image on the basis of a two-dimensional image received from the 3D scanner 10.

Specifically, depending on the control of the processor 150, the communication interface 110 may receive data obtained from the 3D scanner 10, for example, raw data obtained by scanning the oral cavity. Also, the processor 150 may generate a 3D intraoral image representing the oral cavity in three dimension on the basis of the raw data received from the communication interface 110. For example, in order to restore a 3D image according to an optical triangulation method, the 3D scanner 10 may include an L camera corresponding to a left field of view and an R camera corresponding to a right field of view. Also, the 3D scanner may obtain L image data corresponding to the left field of view and R image data corresponding to the right field of view from the L camera and the R camera, respectively. Subsequently, the 3D scanner may transmit the raw data including the L image data and the R image data to the communication interface 110 of the intraoral image processing apparatus 100.

Then, the communication interface 110 may transmit the received raw data to the processor 150, and the processor 150 may generate the intraoral image representing the oral cavity in three dimensions on the basis of the received raw data.

Also, the processor 150 may control the communication interface 110 to directly receive the intraoral image representing the oral cavity in three dimensions from an external server, a medical device, etc. In this case, the processor 150 may acquire the 3D intraoral image without generating the raw data-based 3D intraoral image.

According to an embodiment, the feature, in which the processor 150 performs operations such as ‘extracting,’ ‘obtaining,’ and ‘generating’ may include not only directly performing the above-described operations by executing at least one instruction in the processor 150, but also controlling other components so that the above operations are performed.

In order to practice the embodiments disclosed herein, the intraoral image processing apparatus 100 may include only some of the components shown in FIG. 17 or may include more components in addition to the components shown in FIG. 17.

Also, the intraoral image processing apparatus 100 may store and execute dedicated software that is linked to the 3D scanner 10. Here, dedicated software may be referred to as a dedicated program, dedicated tool, or dedicated application. When the intraoral image processing apparatus 100 operates in conjunction with the 3D scanner 10, the dedicated software stored in the intraoral image processing apparatus 100 may be connected to the 3D scanner 10 and receive, in real time, data obtained by scanning the oral cavity. For example, 3D scanner products produced by Medit Corp. are equipped with dedicated software to process the data obtained by scanning the oral cavity. Specifically, Medit Corp. creates and distributes software to process, manage, use, and/or transmit data obtained from the 3D scanners. Here, the ‘dedicated software’ refers to a program, tool, or application capable of operating in conjunction with the 3D scanner and may be thus commonly used in various 3D scanners developed and sold by various manufacturers. Also, the dedicated software described above may be produced and distributed separately from the 3D scanner that scans the oral cavity.

The intraoral image processing apparatus 100 may store and execute dedicated software corresponding to a 3D scanner product. The dedicated software may perform at least one operation to obtain, process, store, and/or transmit the intraoral image. Here, the dedicated software may be stored in the processor 150. Also, the dedicated software may provide a user interface screen for using data obtained from the 3D scanner. Here, the user interface screen provided by the dedicated software may include the intraoral image created according to the embodiment disclosed herein.

An intraoral image processing method according to an embodiment may be provided in the form of program instructions that may be executed by various computer devices and recorded on a computer-readable medium. Also, an embodiment may include a computer-readable storage medium on which one or more programs including at least one instruction for executing the intraoral image processing method are recorded.

The computer-readable storage medium may include program instructions, data files, data structures, and the like, individually or in combination. Examples of the computer-readable storage medium may include magnetic media, such as hard disks, floppy disks, and magnetic tapes, optical media, such as compact disc read only memory (CD-ROM) and digital versatile discs (DVD), and magneto-optical media, such as floptical disks, and hardware devices, configured to store and execute program commands, such as ROM, RAM, and flash memory.

Here, the machine-readable storage medium may be provided in the form of a non-transitory storage medium. Here, the ‘non-transitory’ may indicate that a storage medium is a tangible device. Also, the ‘non-transitory storage medium’ may include a buffer for temporarily storing data.

According to an embodiment, the intraoral image processing method according to various embodiments may be provided by being included in a computer program product. The computer program product may be distributed in the form of a machine-readable storage medium, for example, CD-ROM. Also, the computer program product may be distributed directly or online (e.g., download or upload), through an application store (e.g., Play Store) or between two user devices (e.g., smartphones). Specifically, the computer program product according to an embodiment may include a storage medium on which a program including at least one instruction for performing the intraoral image processing method according to an embodiment is recorded.

According to the intraoral image processing apparatus and the intraoral image processing method in the embodiments, the original model before the orthodontic treatment and the resultant model after the orthodontic treatment may be provided using the orthodontic simulation.

According to the intraoral image processing apparatus and the intraoral image processing method in the embodiments, if the shape of one of the original model and the resultant model is modified, the modified shape may be reflected in the other model.

According to the intraoral image processing apparatus and the intraoral image processing method in the embodiments, even if the shape of one of the original model and the resultant model is modified, the relationship between the original model and the resultant model may remain the same.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An intraoral image processing method comprising:
obtaining an original model and a resultant model for an object;
modifying, based on a user input, a shape of one of the original model and the resultant model; and
modifying, based on the modified shape, a shape of the other one of the original model and the resultant model.

2. The intraoral image processing method of claim 1, further comprising modifying the other one of the original model and the resultant model while one of the original model and the resultant model is being modified.

3. The intraoral image processing method of claim 1, wherein the modifying of the shape of the other one of the original model and the resultant model comprises modifying the original model or the resultant model in which there has been no user input.

4. The intraoral image processing method of claim 1, wherein the modifying of the shape of the one of the original model and the resultant model comprises at least one of:
convexly sculpting the shape of the object;
concavely sculpting the shape of the object;
smoothing the shape of the object; and
morphing the shape of the object.

5. The intraoral image processing method of claim 1, further comprising:
modifying, based on the user input, a shape of a tooth in one of the original model and the resultant model; and
modifying, based on the modified shape of the tooth, a shape of a tooth in the other one of the original model and the resultant model,
wherein the shape of the original tooth in the original model is same as the shape of the resultant tooth in the resultant model.

6. The intraoral image processing method of claim 1, further comprising:
obtaining a resultant tooth of the resultant model that is moved according to a linear transformation applied to an original tooth of the original model;
modifying a shape of the original tooth based on the user input; and
obtaining a modified resultant tooth by moving the modified original tooth according to the linear transformation.

7. The intraoral image processing method of claim 1, further comprising:
obtaining the resultant model having a resultant tooth that is moved according to a linear transformation applied to an original tooth of the original model;
modifying a shape of the resultant tooth based on the user input; and
obtaining a modified original tooth by moving the modified resultant tooth according to an inverse-linear transformation.

8. The intraoral image processing method of claim 1, further comprising:
modifying, based on the user input, a shape of a gingiva in one of the original model and the resultant model; and
modifying, based on the modified shape of the gingiva, a shape of a gingiva in the other one of the original model and the resultant model,
wherein the shape of the resultant gingiva of the resultant model is modified by reflecting a movement of a tooth in the shape of the original gingiva of the original model.

9. The intraoral image processing method of claim 1, further comprising:
obtaining the resultant model having a resultant gingiva modified by reflecting an amount of a tooth movement in an original gingiva of the original model;
modifying a shape of the original gingiva based on the user input; and
modifying a shape of the resultant gingiva by reflecting the amount of the tooth movement in the modified original gingiva.

10. The intraoral image processing method of claim 1, further comprising:
obtaining the resultant model having a resultant gingiva modified by reflecting the amount of the tooth movement in an original gingiva of the original model;
primarily modifying a shape of the resultant gingiva based on the user input;
modifying the shape of the original gingiva based on the primarily modified resultant gingiva; and
secondarily modifying the shape of the resultant gingiva by reflecting the amount of tooth movement in the modified original gingiva.

11. The intraoral image processing method of claim 10, wherein the modifying of the shape of the original gingiva based on the primarily modified resultant gingiva comprises:
obtaining a target point of the original gingiva in response to a user input point of the primarily modified resultant gingiva; and
modifying the original gingiva based on a direction of a normal vector for a target point of the original gingiva.

12. The intraoral image processing method of claim 9, wherein the modifying of the shape of the resultant gingiva comprises modifying or secondarily modifying the shape of the resultant gingiva, based on release of the user input.

13. The intraoral image processing method of claim 1, further comprising:
obtaining a plurality of resultant models for the object;
modifying, based on a user input, a shape of one among the original model and the plurality of resultant models; and
modifying, based on the modified shape, shapes of the other models among the original model and the plurality of resultant models.

14. An intraoral image processing apparatus comprising:
a display;
memory storing one or more instructions; and
at least one processor,
wherein the at least one processor is configured to execute the one or more instructions to:
obtain an original model and a resultant model for an object;
modify, based on a user input, a shape of one of the original model and the resultant model; and
modify, based on the modified shape, a shape of the other one of the original model and the resultant model.

15. The intraoral image processing apparatus of claim 14, wherein the at least one processor is further configured to execute the one or more instructions to modify the other one of the original model and the resultant model while one of the original model and the resultant model is being modified.

16. The intraoral image processing apparatus of claim 14, wherein the at least one processor is further configured to execute the one or more instructions to modify the original model or the resultant model in which there has been no user input.

17. The intraoral image processing apparatus of claim 14, wherein the at least one processor is further configured to execute the one or more instructions to:
modify, based on the user input, a shape of a tooth in one of the original model and the resultant model; and
modify, based on the modified shape of the tooth, a shape of a tooth in the other one of the original model and the resultant model,
wherein the shape of the original tooth in the original model is same as the shape of the resultant tooth in the resultant model.

18. The intraoral image processing apparatus of claim 14, wherein the at least one processor is further configured to execute the one or more instructions to:
modify, based on the user input, a shape of a gingiva in one of the original model and the resultant model; and
modify, based on the modified shape of the gingiva, a shape of a gingiva in the other one of the original model and the resultant model,
wherein the shape of the resultant gingiva of the resultant model is modified by reflecting a movement of a tooth in the shape of the original gingiva of the original model.

19. The intraoral image processing apparatus of claim 14, wherein the at least one processor is further configured to execute the one or more instructions to:
obtain the resultant model having a resultant gingiva modified by reflecting an amount of a tooth movement in an original gingiva of the original model;
primarily modify a shape of the resultant gingiva based on the user input;
modify the shape of the original gingiva based on the primarily modified resultant gingiva; and
secondarily modify the shape of the resultant gingiva by reflecting the amount of the tooth movement in the modified original gingiva.

20. A computer-readable recording medium having recorded thereon a program for performing the method of claim 1 on a computer.
